(19) United States
(12) Patent Application Publication
(10) Pub. No.: US 2024/0273407 A1
(43) Pub. Date: Aug. 15, 2024

(54) HIGH-DIMENSIONAL VECTOR SPACE ENCODING TECHNIQUES FOR HYPERDIMENSIONAL COMPUTING SYSTEMS

(71) Applicant: The Regents of the University of California, Oakland, CA (US)

(72) Inventors: Behnam Khaleghi, La Jolla, CA (US); Jaeyoung Kang, San Diego, CA (US); Hanyang Xu, San Diego, CA (US); Justin Morris, San Diego, CA (US); Tajana Rosing, San Diego, CA (US); Uday Bhanu Sharma Mallappa, Sunnyvale, CA (US); Haichao Yang, La Jolla, CA (US); Monil Shah, Austin, TX (US)

(21) Appl. No.: 18/441,318

(22) Filed: Feb. 14, 2024

Related U.S. Application Data
(60) Provisional application No. 63/485,128, filed on Feb. 15, 2023.

(51) Int. Cl. G06N 20/00

(52) U.S. Cl. CPC G06N 20/00

(57) ABSTRACT

Disclosed herein are techniques and architectures for encoding data within a hyperdimensional computing (HDC) framework, enabling the transformation of input data into high-dimensional vector space representations. Embodiments herein facilitate the segmentation of data into multiple windows, selection of level hypervectors corresponding to data elements, application of permutation operations for positional encoding, and execution of binary operations to synthesize window hypervectors. The aggregation of such window hypervectors yields an encoded hypervector that encapsulates a representation of the original data in HDC space. The disclosed embodiments are adept at handling various data types, including textual, image, voice, or sensor data, providing for broad applicability and adaptability in encoding for hyperdimensional computing applications.

### CROSS-REFERENCE TO RELATED APPLICATIONS

This application claims the benefit of U.S. Provisional Application No. 63/485,128, entitled “Methods, Circuits, And Systems Including Efficient Learning Engine On Edge Using Hyperdimensional Computing And Efficient Deep Neural Network Acceleration With Filter Sharing,” filed on Feb. 15, 2023, the disclosure of which is hereby incorporated by reference in its entirety.

This application is being filed on Feb. 14, 2024, concurrently with the following U.S. patent application, which is incorporated by reference herein in its entirety:

| Attorney Docket | | |
|---|---|---|
| No. | Patent Application Title | Filing Date |
| 170964-00078A2 | Deep Neural Network Operation | Feb. 14, 2024 |
| | Via Patterned Filter Clustering | |
| | And Activation Group Reuse | |

### STATEMENT OF GOVERNMENT SUPPORT

This invention was made with government support under Grant No. HR0011-18-3-0004 awarded by the Department of Defense Advanced Research Projects Agency (DARPA). The government has certain rights in the invention.

### FIELD

The present disclosure generally relates to information processing systems and, more particularly, to methods and systems for encoding data within hyperdimensional computing frameworks.

### BACKGROUND

Hyperdimensional Computing (HDC) is a brain-inspired learning paradigm based on the observation that brains perform cognitive tasks by mapping sensory inputs to high-dimensional neural representation. The paradigm enables the brain to carry out simple, low-power, error-resilient, and parallelizable operations all in the hyperspace. Such characteristics of HDC make it appealing for a wide variety of applications such as IoT domain that generates an increasing amount of data with tight resource and energy constraints. Conventional processing platforms such as CPUs and GPUs may not take full advantage of the highly-parallel bit-level operations of HDC. Furthermore, existing HDC encoding techniques often do not cover a broad range of applications to make a custom design plausible.

The increasing effectiveness of Deep Neural Networks (DNNs) across various application areas is paralleled by an expansion in both the size and computational requirements of their models. To address the challenges related to the memory and computational demands of DNNs, considerable research efforts have been dedicated to developing compression techniques. These techniques include weight quantization, pruning, clustering, and filter pruning, with particular emphasis on enhancing hardware efficiency through hardware-aware quantization and structured pruning. In the context of weight quantization, it can include the assignment of network parameters to a predefined set of values, such as in uniform quantization.

Weight clustering is an effective technique for compressing deep neural networks (DNNs) memory by using a limited number of unique weights and low-bit weight indexes to store clustering information. Weight clustering consolidates weights into clusters, assigning a single value to all weights within a cluster. This allows for the storage of just the cluster index or ID for each weight in an index table, accompanied by a smaller table mapping these indexes to actual weight values. Prior studies have demonstrated that maintaining approximately 16 unique weights can preserve model accuracy, effectively doubling memory efficiency by replacing 8-bit weight representations with 4-bit index values.

### SUMMARY

Some embodiments of the present disclosure relate to encoding techniques that can enhance accuracy for a wide array of applications. Disclosed herein is an Application-Specific Integrated Circuits (ASIC) accelerator system that leverages the encoding techniques and can be optimized for edge computing environments. The ASIC accelerator system can support classification (e.g., encompassing both training and inference) and clustering for unsupervised learning, demonstrating an adaptability to various application requirements and hypervectors dimensionality. Such adaptability can enable the ASIC accelerator system to dynamically adjust between accuracy and energy/performance efficiency on demand. In some cases, the ASIC accelerator system can be augmented with application-opportunistic power-gating and voltage over-scaling strategies, exploiting the inherent error resilience of Hyperdimensional Computing (HDC) for further reductions in energy consumption. The encoding techniques described herein can significantly improve prediction accuracy over existing HDC and machine learning techniques, setting a new standard in the field. Further, the ASIC accelerator system can offer substantial improvements in energy efficiency over previous solutions, marking a significant advancement in ASIC accelerator technology for edge computing applications.

Some embodiments of the present disclosure relate to techniques and architectures for encoding data within a hyperdimensional computing (HDC) framework, enabling the transformation of input data into high-dimensional vector space representations. Embodiments herein facilitate the segmentation of data into multiple windows, selection of level hypervectors corresponding to data elements, application of permutation operations for positional encoding, and execution of binary operations to synthesize window hypervectors. The aggregation of such window hypervectors yields an encoded hypervector that encapsulates a representation of the original data in HDC space. This process can include the use of exclusive OR (XOR) operations for binary execution, predefined sets of level hypervectors for quantization, or unique identifier hypervectors for incorporating global sequence information. The disclosed embodiments are adept at handling various data types, including textual, image, voice, or sensor data, providing for broad applicability and adaptability in encoding for hyperdimensional computing applications.

Some embodiments of the present disclosure relate to a pattern clustering system, which can be designed to enforce shared clustering topologies on filters, thereby leading to a significant reduction in memory usage through the reuse of index information. The pattern clustering system can effectively factorize input activations and post-process unique weights, substantially decreasing the requirement for multiplication operations. In some cases, the pattern clustering system can reduce the number of addition operations by leveraging the fact that filters sharing a clustering pattern have identical factorized terms. Some embodiments of the present disclosure relate to techniques for determining and assigning clustering patterns, as well as for training a network to adhere to these target patterns. Some embodiments of the present disclosure relate to an efficient accelerator based on the patterned filters. The pattern clustering system can reduce both the memory footprint and the operation count, while maintaining accuracy comparable to that of baseline models. Furthermore, the accelerator for the pattern clustering system can significantly enhance energy efficiency, surpassing the performance of conventional technologies and setting a new benchmark in the field.

### BRIEF DESCRIPTION OF THE DRAWINGS

Throughout the drawings, reference numbers can be re-used to indicate correspondence between referenced elements. The drawings are provided to illustrate embodiments of the present disclosure and do not to limit the scope thereof.

FIGS. 1A-1C demonstrate example HDC training and inference. FIG. 1A illustrates an example initial training (initialization) phase, FIG. 1B illustrates an example inference phase, and

FIG. 1C illustrates an example retraining phase of an HDC model.

FIG. 2A illustrates an example association of hypervectors with raw input features, known as level hypervectors, which represent scalar elements in hyperspace.

FIG. 2B illustrates an example permutation encoding process where level hypervectors are circularly shifted for positional encoding in HDC.

FIG. 2C illustrates an example random projection (RP) encoding technique, showing how input indices can be combined with their levels using a binary XOR operation.

FIG. 3A illustrates an example encoding method in accordance with aspects of the inventive concept, focusing on processing sliding windows of length n and applying permutation encoding to achieve higher accuracy across various applications.

FIG. 3B illustrates Table 1, which presents example accuracy results of various encoding techniques including random projection, multi-layer perceptron, support vector machine, and random forest, highlighting the superior accuracy of the ASIC accelerator system encoding compared to these techniques.

FIG. 4A graphically represents the energy consumed during the training and inference phases of various algorithms, including HDC and ML, on different computational platforms such as Raspberry Pi, CPU, and eGPU, providing a comparison of energy efficiency.

FIG. 4B depicts the time required to complete the training and inference phases for the algorithms and platforms of FIG. 4A, providing a comparison of relative computational speed and performance efficiency.

FIG. 5 shows an example ASIC accelerator system, according to embodiment of the present inventive concept.

FIG. 6 illustrates the impact of using constant versus updated L2 norms in the ASIC accelerator system, showing the accuracy differences in EEG and ISOLET datasets.

FIG. 7 shows an example relationship between class memory error rate and accuracy in different benchmarks.

FIG. 8 provides a breakdown of the area and power consumption of the ASIC accelerator system.

FIG. 9 compares the training energy and execution time of the ASIC accelerator system with other methods.

FIG. 10A compares the energy consumption of the ASIC accelerator system and baselines.

FIG. 10B illustrates Table 2, which compares the normalized mutual information score of the K-means and HDC for the FCPS benchmarks and the Iris flower dataset.

FIG. 11 compares the per-input energy consumption of the ASIC accelerator system with K-means clustering on different hardware.

FIGS. 12A and 12B illustrate an example convolution operation in CNNs.

FIG. 13 illustrates the convolution layer parameters, illustrating output activation generation via dot-products of filters with input windows.

FIG. 14 illustrates parameter memory and operation reduction in patterned VGG-16 layers, emphasizing efficiency through shared clustering patterns.

FIG. 15 illustrates the pattern selection process, displaying filter weight clustering into groups for similar pattern assignment.

FIG. 16 illustrates an example algorithm for an example training process in the pattern clustering system.

FIG. 17A illustrates the pattern clustering system accelerator's architecture and data flow.

FIG. 17B illustrates Table 3, which summarizes the accuracy, operation count (ADD and MUL), and memory for the aforementioned models and datasets.

FIG. 17C illustrates Table 4, which reports the size of the pattern clustering system memories.

FIG. 17D illustrates Table 5, which shows the per-component area and delay of the pattern clustering system.

FIGS. 18A and 18B show the scalability of the pattern clustering system, comparing performance across different array sizes for image processing.

FIG. 19 illustrates the energy efficiency of the pattern clustering system compared with other architectures.

### DETAILED DESCRIPTION

Hyperdimensional Computing (HDC) often uses algorithms to encode raw inputs to a high-dimensional representation of hypervectors with Dₕₒ≈2-5K dimensions. The encoding can take place by deterministically associating each element of an input with a binary or bipolar (±1) hypervector and bundling (element-wise addition) the hypervectors of all elements to create the encoded hypervector. Training can involve bundling all encoded hypervectors of the same category. For inference, the query input can be encoded to a hypervector in the same or similar fashion and compared with all class hypervectors using a simple similarity metric, such as cosine.

In some cases, the bit-level massively parallel operations of HDC do not accord well with conventional CPUs/GPUs due to, e.g., memory latency and data movement of large vectors or the fact that these devices are over-provisioned for majorly binary operations of HDC. Furthermore, solutions for custom HDC accelerators often suffer from limitations such as supporting only a narrow range of applications, achieving lower accuracy compared to baseline ML algorithms, or consuming significantly more energy.

Disclosed herein are inventive concepts that address these or other problems. Some inventive concepts herein relate to an ASIC accelerator system (sometimes referred to as a highly efficient learning engine on edge using hyperdimensional computing or GENERIC) for efficient and accurate trainable classification and clustering. The ASIC accelerator system can be compact and low-power (e.g., to meet year-long battery-powered operation) and/or can be fast during training and burst inference, e.g., when it serves as an IoT gateway.

Some inventive concepts herein relate to an HDC encoding that yields high accuracy in various benchmarks. Some inventive concepts herein relate to an ASIC accelerator system that can implement accurate HDC-based trainable classification and clustering. The ASIC accelerator system can benefit from extreme energy reduction techniques such as, but not limited to, application-opportunistic power gating, on-demand dimension reduction, and error-resilient voltage over-scaling. The ASIC accelerator system can improve the classification accuracy (e.g., by 3.5% over previous HDC techniques and 6.5% over ML techniques). The ASIC accelerator system can improve energy consumption (e.g., by 4.1× and 15.7×compared to previous HDC accelerators).

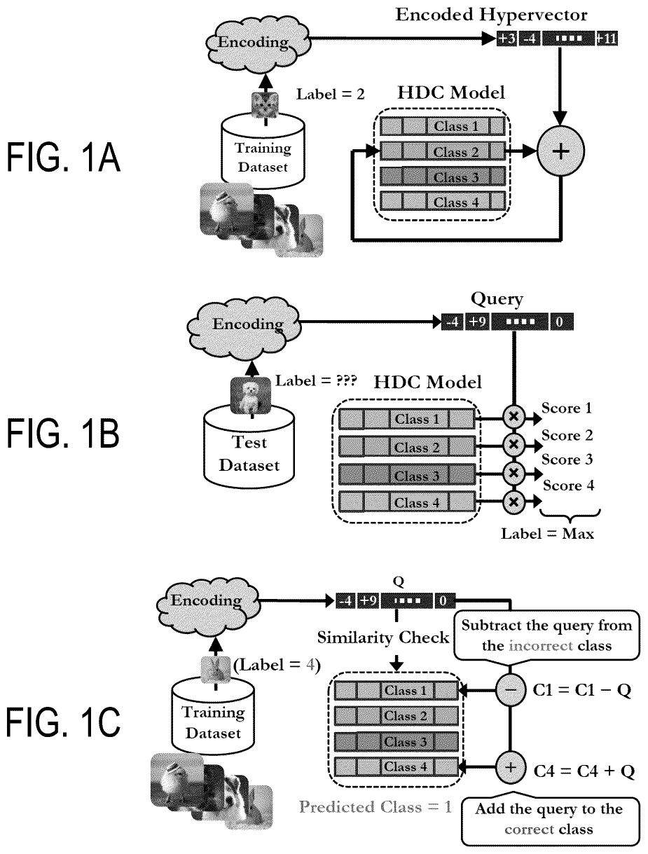

FIGS. 1A-1C demonstrate example HDC training and inference. During training, each input X is encoded to a hypervector H(X) and added up to its class hypervector. In the inference, the query is likewise encoded and compared with class hypervectors. The class index with the highest similarity score is returned as the prediction result. In this example, cosine distance of the query and class hypervectors as the similarity metric. The accuracy of an HDC model can be improved by retraining iterations where the encoded train data are compared with the HDC model, and in case of misprediction, the model is updated by subtracting the encoded hypervector from the mispredicted class and adding it to the correct class.

The similarity of hypervectors indicates their proximity, which can be used to cluster data in the hyperspace. Initially, k encoded hypervectors are selected as clusters centroids. At each iteration, all encoded inputs are compared with the centroids and added to the closest (highest score) centroid hypervector. In classification, the model is updated right away. However, in clustering, the model is fixed and used for finding the similarities, and a new model is created from scratch, which replaces the current model in the next iteration.

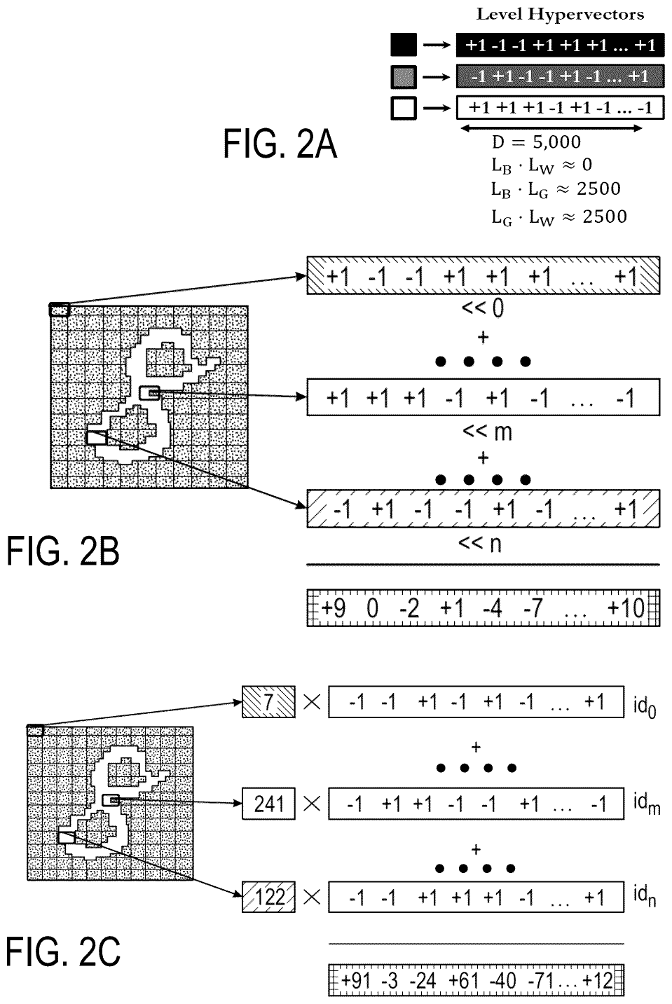

FIG. 2A illustrates an example association of hypervectors with raw input features, known as level hypervectors, which represent scalar elements in hyperspace. FIG. 2B illustrates an example permutation encoding process where level hypervectors are circularly shifted for positional encoding in HDC. FIG. 2C illustrates an example random projection (RP) encoding technique, showing how input indices can be combined with their levels using a binary XOR operation.

Encoding can be an important step of HDC. Some encoding techniques map the inputs to high dimensional space. Most encodings associate hypervectors with the raw input features (elements), called level hypervector (see FIG. 2A), which are hyperspace representative of scalar elements. Usually, inputs are quantized into bins to limit the number of levels. If there is a meaningful distance between the input elements (as in the values of white and black pixels), this distance can be preserved when generating the levels.

Encoding of an input can be accomplished by aggregating the level hypervectors of its elements. To handle the positional order of elements, which can be important in most datasets such as image or voice, HDC can use variants of binding. The permutation encoding of FIG. 2B carries out binding by circular shift of the level hypervectors; the level hypervector of mth feature is permuted by m indexes. Some other encodings such as random projection (RP), shown in FIG. 2C, or level-id use id hypervectors for binding. In these encodings, each input index has a random (but constant) binary id, which is multiplied (XOR in the binary domain) with its level, and the result vector is aggregated with that of other indexes.

Conventional encoding techniques can achieve low accuracy for certain datasets such as language identification which generally need extracting local subsequences of consecutive features, without considering the global order of these subsequences. Some previous studies use ngram encoding for such datasets. Ngram encoding extracts all subsequences of length n (usually n∈{3-5}) in a given input, encodes all these subsequences and aggregates them to produce the encoded hypervector. However, ngram encoding may achieve very low accuracy for datasets such as images or voices in which the spatio-temporal information of should be taken into account. Disclosed herein is a new encoding that can advantageously cover a more versatile set of applications.

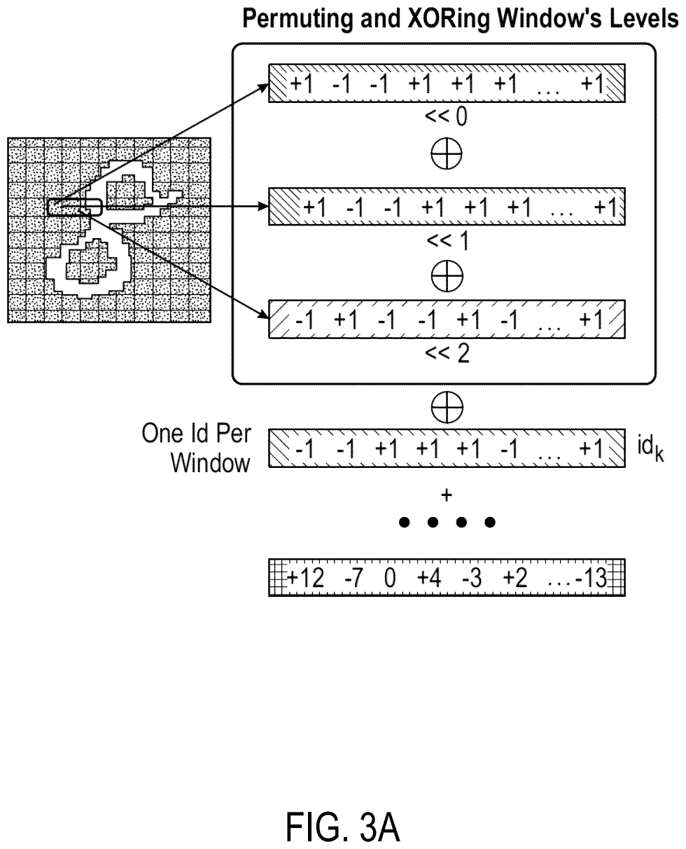

FIG. 3A illustrates an example encoding method in accordance with aspects of the inventive concept, focusing on processing sliding windows of length n and applying permutation encoding to achieve higher accuracy across various applications. That is, for every window consisting of elements {xₖ, xₖ₊₁, xₖ₊₂} (for n=3), three level hypervectors are selected, where l (xₖ), [symbol] (xₖ₊₁), and [symbol] (xₖ₊₂) are permuted by 0, 1, and 2 indexes, respectively. The permuted hypervectors can be XORed elementwise to create the window hypervector. The permutation accounts for positional information within a window, e.g., to distinguish “abc” and “bca”. To account for global order of features, a random but constant id hypervector can be associated with each window, which can be XORed with the window hypervector to perform binding. In some cases, the global binding is omitted. For example, in certain applications, id hypervectors are set to [symbol] .

Equation (1) outlines an example encoding process, in accordance with aspects of the inventive concept. In Equation (1), ρ^{(j)} indicates permutation by j indexes, Π multiplies (XOR in binary) the levels of ith window, idᵢ applies the binding id, and Σ adds up the window hypervector for all windows of d elements.

$$ℋ ( 𝒳 ) = {\sum }_{i = 1}^{d - n + 1} ( {id}_{i} \cdot {\prod }_{j = 0}^{n - 1} {ρ}^{j} ( ℓ ( {x}_{i + j} ) ) ) \qquad ( 1 )$$

In this example, n=3 as it achieved the highest accuracy (on average) for the examined benchmarks. However, the value of n can vary across embodiment. In some cases, the ASIC accelerator system can adjust the value of n for every application.

As shown in Table 1, eleven datasets were compiled from different domains, including certain benchmarks, seizure detection by skull surface EEG signals, and user activity recognition by motion sensors. In this example, the HDC algorithms were implemented using an optimized Python implementation that leverages SIMD operations. For ML techniques, a Python scikit-learn library was used. Some of results of logistic regression and k-nearest neighbors were discarded, as they achieved lower accuracy. For DNN models of benchmarks, an AutoKeras library for automated model exploration was used.

Table 1 summarizes the accuracy results (RP: random projection, MLP: multi-layer perceptron, SVM: support vector machine, RF: random forest). As shown, in this example, the disclosed ASIC accelerator system encoding achieves 3.5% higher accuracy than the best baseline HDC (level-id), 6.5% higher than best baseline ML (SVM), and 1.0% higher than DNN. The RP encoding fails in time-series datasets that require temporal information (e.g., EEG). In some cases, the ngram encoding does not capture the global relation of the features, so it fails in datasets such as speech (ISOLET) and image recognition (MNIST). In some cases, except for the ngram and the disclosed ASIC accelerator system, other HDC techniques fail in the LANG (text classification) as they enforce capturing sequential information and ignore subsequences.

HDC's operations can be simple and highly parallelizable. However, conventional processors may not be optimized for binary operations such as one-bit accumulation. Also, the size of hypervectors in most settings can become larger than the cache size of low-end edge processors, which may impose significant performance overhead. The HDC and ML algorithms can be implemented on the datasets on a Raspberry Pi 3 embedded processor and NVIDIA Jetson TX2 low-power edge GPU, and also a desktop CPU (Intel Core i7-8700 at 3.2 GHz) with a larger cache. A Hioki 3334 power meter was used to measure the power of the Raspberry Pi.

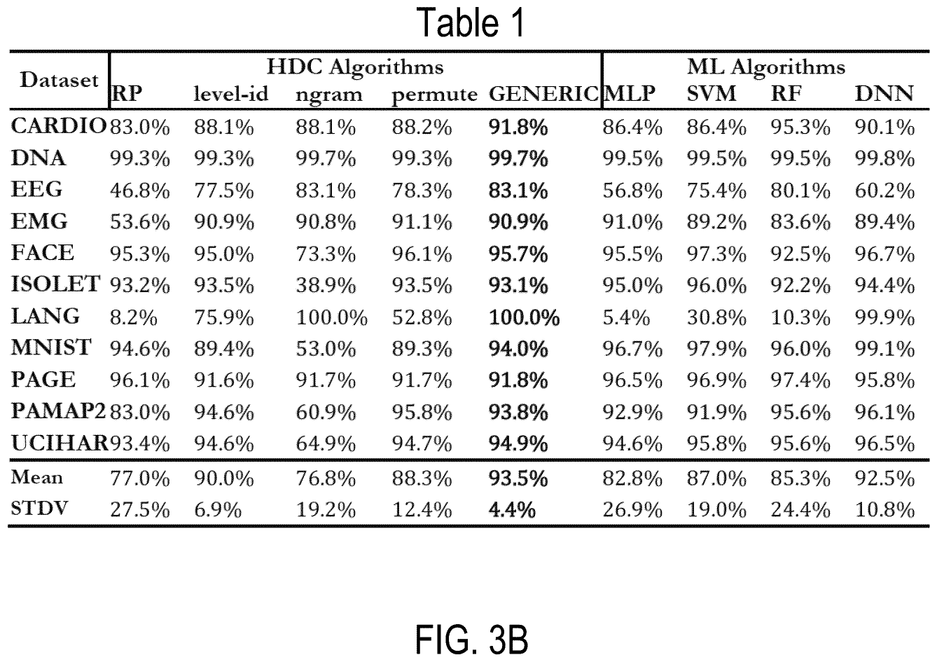

FIGS. 4A and 4B compare the training and inference (a) energy consumption and (b) execution time of the algorithms, reported as the geometric mean of all benchmarks. For eGPU, the results of conventional ML were omitted, as it performed worse than CPU for a variety of libraries. As shown by FIGS. 4A and 4B, (i) conventional ML algorithms, including DNN, can consume smaller energy than HDC on all devices, (ii) the ASIC accelerator system encoding, due to processing multiple hypervectors per window, can be less efficient than other HDC techniques, and (iii) the eGPU implementation, by data packing (for parallel XOR) and memory reuse, can significantly improve the HDC execution time and energy consumption. For instance, eGPU can improve the energy usage and execution time of the ASIC accelerator system inference by 134× and 252× over running on low-end Raspberry Pi (70× and 30× over CPU). However, the ASIC accelerator system running on eGPU can consume 12× (3×) more inference (train) energy, with 27× (111×) higher execution time than an efficient baseline (random forest). Nonetheless, eGPU numbers imply substantial energy and runtime reduction potential for HDC by effectively taking advantage of low-precision operations (achieved by bit-packing in eGPU) and high parallelism.

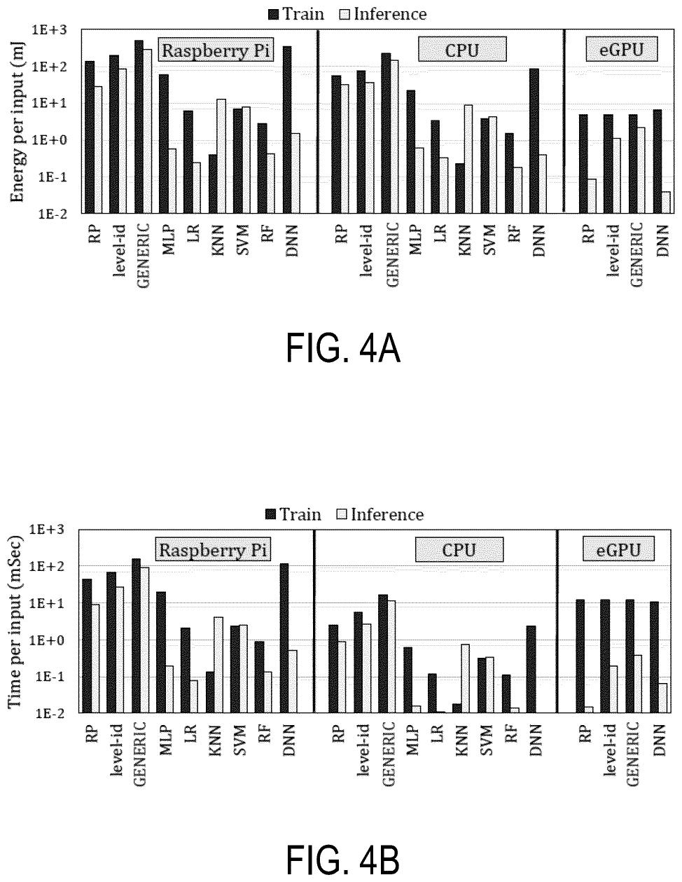

FIG. 5 shows an example ASIC accelerator system 500, according to some embodiments of the present inventive concept. Inputs to the ASIC accelerator system 500 can include, but are not limited to, (i) an input port 502 to read an input (including the label in case of training) from the serial interface element by element and store in the input memory before starting the encoding, (ii) a config port 504 to load the level, and class hypervectors (in case of offline training), and (iii) a spec port 506 to provide the application characteristics to the controller, such as [symbol] ₕᵥ dimensionality, d elements per input, n length of window, nC number of classes or centroids, bw effective bit-width, and mode (training, inference, or clustering). Output port 508 can return the labels of inference or clustering.

The controller 510, e.g., by using spec data, handles the programmability of the ASIC accelerator system 500 and orchestrates the operations. For instance, the encoder generates m=16 (architectural constant) partial dimensions after each iteration over the stored input, where the variable [symbol] ₕᵥ signals the end of encoding to finalize the search result, d denotes the number of input memory rows to be proceeded to fetch features (i.e., the exit condition for counter), nC indicates the number of class memory rows that need to be read for dot-product and so on. The class memory layout of the ASIC accelerator system 500 can allow a tradeoff between the hypervectors length [symbol] ₕᵥ and supported classes nC. By default, the ASIC accelerator system class memories can store [symbol] ₕᵥ=4K for up to nC=32 classes. For an application with less than 32 classes, higher number of dimensions can be used (e.g., 8K dimensions for 16 classes). These application-specific input parameters enable the ASIC accelerator system 500 the flexibility to implement various applications without requiring a complex instruction set or reconfigurable logic.

Features can be fetched one by one from the input memory 520 and quantized to obtain the level bin, and accordingly, m (16) bits of the proper level hypervector are read. The levels are stored as m-bit rows in the level memory 530. The stacked registers (reg n to 1) facilitate storing and on-the-fly sliding of level hypervectors of a window. Each pass over the input features generates m encoding dimensions, which can be used for dot-product with the classes. The class hypervectors are distributed into m memories (CM 1 to CM m) to enable reading m consecutive dimensions at once. The dot-product of partial encoding with each class can be summed up in the pipelined adder 516, and accumulated with the dot-product result of previous/next m dimensions in the score memory 517.

After [symbol] iterations, all dimensions are generated, and the dot-product scores are finalized. The system 500 can use cosine similarity metric between the encoding vector H and class Cᵢ:

$${δ}_{i} = \frac{ℋ \cdot {C}_{i}}{{‖ ℋ ‖}_{2} \times {‖ {C}_{i} ‖}_{2}} .$$

The system 500 can normalize the dot-product result with L2 norms. The ∥ [symbol] ∥₂ can be removed from the denominator as it is a constant and does not affect the rank of classes. In addition, to eliminate the square root of ∥Cᵢ∥₂, the system 500 can modify the metric to

$${δ}_{i} = \frac{{( ℋ \cdot {C}_{i} )}^{2}}{{‖ {C}_{i} ‖}_{2}^{2}}$$

without affecting the predictions. The norm2 memory 518 stores the squared L2 norms of classes, and similarly, the squared score is passed to the divider 519. The system 500 can use an approximate log-based division.

### Training and Retraining

In the first round of training, e.g., model initialization, encoded inputs of the same class/label are accumulated. It can be done through the adder 514 and mux 513 of all class memories. The controller 510 uses the input label and the iteration counter to activate the proper memory row. In the next retraining epochs, the model is examined and updated in case of misprediction (see FIGS. 1A-1C). Thus, during retraining, meanwhile performing inference on the training data, the encoded hypervector is stored in temporary rows of the class memories (through the second input of mux 513). If updating a class is required, the class rows are read and latched in the adder 514, followed by reading the corresponding encoded dimensions from the temporary rows and writing the new class dimensions back to the memory. Hence, each update takes 3× [symbol] cycles. Training may also require calculating the squared L2 norm of classes in the norm2 memory 518. As it can be seen in FIG. 5, the class memories are able to pass the output into both ports of the multipliers (one direct and another through the mux) to calculate and then accumulate the squared elements.

### Clustering

The ASIC accelerator system 500 selects the first k encoded inputs as the initial cluster centroids and initializes k centroids in the class memories. The system allocates two sets of memory rows for temporary data; one for the incoming encoding generated in the encoding module and another for the copy centroids (clustering generates a new copy instead of direct update). Similarity checking of the encoding dimensions with the centroids is done pipelined similar to inference, but the encoded dimensions are stored to be added to the copy centroid after finalizing the similarity checking. After finding the most similar centroid, the copy centroid is updated by adding the stored hypervector (similar to retraining). The copy centroids serve as the new centroids in the next epoch.

### Energy Reduction

The ASIC accelerator system 500 can enable energy efficiency. The following elaborates energy-saving techniques that benefit the ASIC accelerator system 500. These techniques can also be applied to other HDC accelerators.

### id Memory Compression

The id memory naturally needs 1K×4K=512 KB (for up to 1K features per input, and [symbol] ₕᵥ=4K dimensions) which occupies a large area and consumes huge power. However, the ASIC accelerator system 500 generates ids on-the-fly using a seed id vector, where kth id is generated by permuting the seed id by k indexes. Therefore, the id memory shrinks to 4 Kbit, i.e., 1024× reduction. Permutation preserves the orthogonality. It is implemented by the tmp register 512, by which, for a new window, the reg id is right-shifted and one bit of tmp is shifted in. The tmp register helps to avoid frequent access to the id memory by reading m (16) bits at once and feeding in the next m cycles.

### Application-Opportunistic Power Gating

For an application with nC classes and using [symbol] ₕᵥ dimensions, the ASIC accelerator system 500 stripes the dimensions 1 to m (16) of its 1st class vector in the 1st row of m class memories, the 2nd class vector in the 2nd row, and so on. The next m dimensions of the 1st class vector are therefore written into nc+1th row, followed by the other classes. Thus, in some cases, the ASIC accelerator system 500 always uses the first [symbol] portion of class memories. The applications can fill 28% of the class memories (minimum 6% for EEG/FACE, and maximum 81% for ISOLET) using [symbol] ₕᵥ=4K dimensions. Accordingly, the ASIC accelerator system 500 can partition each class memory into four banks and power gates the unused banks. With four banks, 1.6 out of four banks are activated on average, leading to 59% power saving. With more fine-grained eight banks, 2.7 banks (out of eight) become active, saving 66% power. However, eight banks impose 55% area overhead compared to 20% of four banks. In some cases, the four bank configuration yields the minimum area×power cost. Since the power gating is static (permanent) for an application, no wake-up latency or energy is involved.

### On-Demand Dimension Reduction

The ASIC accelerator system 500 can trade the energy consumption and performance with accuracy. Recall that the ASIC accelerator system 500 generates m dimensions of the encoding per iteration over the features. By feeding a new D_hv value as input, the ASIC accelerator system 500 can seamlessly use the new dimension count by updating the counter exit condition, so smaller hypervectors of the encoding and class hypervectors will be used. Nevertheless, the ASIC accelerator system stores 500 the squared L2 norms of the whole classes for similarity metric

$$( {δ}_{i} = \frac{{( ℋ \cdot {C}_{i} )}^{2}}{{‖ {C}_{i} ‖}_{2}^{2}} )$$

while for arbitrary reduced encoding dimensions, only the corresponding elements (and their L2 norms) of the classes are needed.

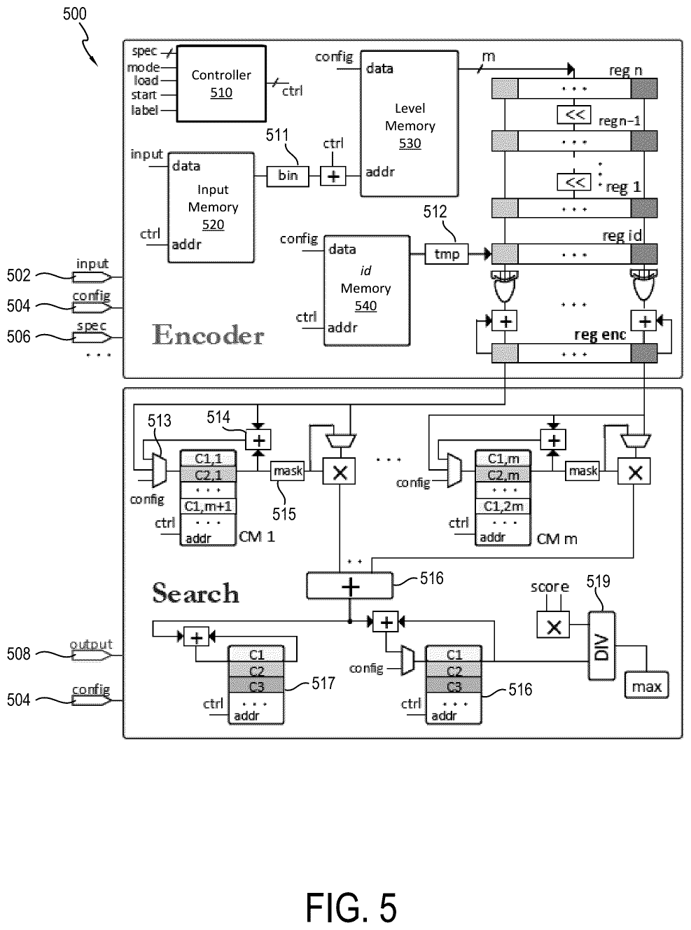

FIG. 6 illustrates the impact of using constant versus updated L2 norms in the ASIC accelerator system 500, showing the accuracy differences in EEG and ISOLET datasets. As FIG. 6 shows, using the old (Constant) L2 values causes significant accuracy loss compared to using the recomputed (Updated) L2 norm of sub-hypervectors. The difference can be up to 20.1%, or more, for EEG and 8.5% for ISOLET. To address this issue, when calculating the squared L2 norms during the training, the ASIC accelerator system 500 stores the L2 norms of every 128th-dimension sub-class in a different row of the norm2 memory 518. Thus, dimensions can be reduced with a granularity of 128 while keeping the norm2 memory small (2 KB for 32 classes).

### Voltage Over-Scaling

The ASIC accelerator system 500 can use 16-bit class dimensions to support training. As a result, the large class memories consume ˜80% of the total power. HDC exhibits notable tolerance to the bit-flip of vectors, which can be leveraged to over-scale the memory voltage without performance loss.

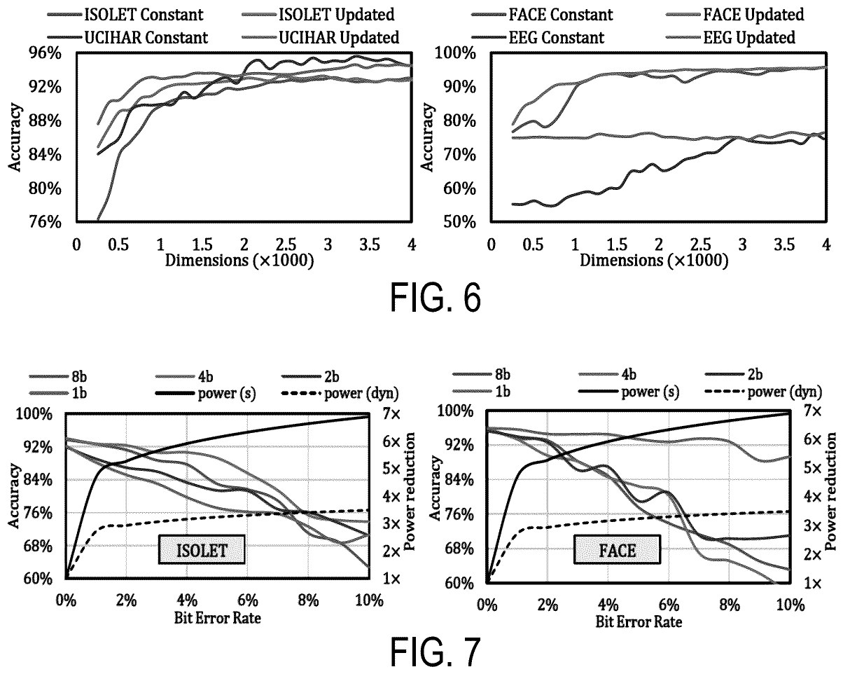

FIG. 7 shows an example relationship between class memory error rate and accuracy in different benchmarks. In particular, FIG. 7 shows the accuracy of select benchmarks (ISOLET and FACE) with respect to the class memory error. The static (s) and dynamic (dyn) power saving as a result of corresponding voltage scaling (without reducing clock cycle) is also shown in the right axis. The figure shows the result of the HDC models with different bit-width (bw input parameter of the ASIC accelerator system) of classes by loading a quantized HDC model (the mask unit 512 in the architecture masks out the unused bits). As can be seen, error tolerance not only depends on application but also on the bit-width. 1-bit FACE model shows a high degree of error tolerance (hence, power saving) by up to 7% bit-flip error rate, while ISOLET provides acceptable accuracy by up to 4% bit-flip using a 4-bit model. Quantized elements also reduce the dynamic power of dot-product.

Voltage over-scaling also depends on the application's sensitivity to dimension reduction and its workload. For instance, FACE has a higher tolerance to voltage scaling than dimension reduction (see FIG. 6). On the other hand, ISOLET is more sensitive to voltage reduction but achieves good accuracy down to 1K dimensions (FIG. 6), which means 4× energy reduction compared to 4K dimensions. Thus, voltage over-scaling for ISOLET is only preferred in workloads with a higher idle time where the static power dominates (voltage scaling reduces the static power more significantly).

### Results

The ASIC accelerator system 500 was implemented at the RTL level in SystemVerilog and verified the functionality in Modelsim. Synopsys Design Compiler was used to synthesize The ASIC accelerator system 500 targeting 500 MHz clock with 14 nm Standard Cell Library of GlobalFoundries. Artisan memory compiler was used to generate the SRAM memories. The level memory 530 has a total size of 64×4K=32 KB for 64 bins, the feature memory is 1024×8b, and class memories are 8K×16b (16 KB each). The power consumption was obtained using Synopsys Power Compiler. The ASIC accelerator system 500 occupies an area of 0.30 mm² and consumes a worst-case static power of 0.25 mW when all memory banks are active. For datasets of Section 3.2, the ASIC accelerator system 500 consumes a static and dynamic power of 0.09 mW, and 1.79 mW, respectively (without voltage scaling).

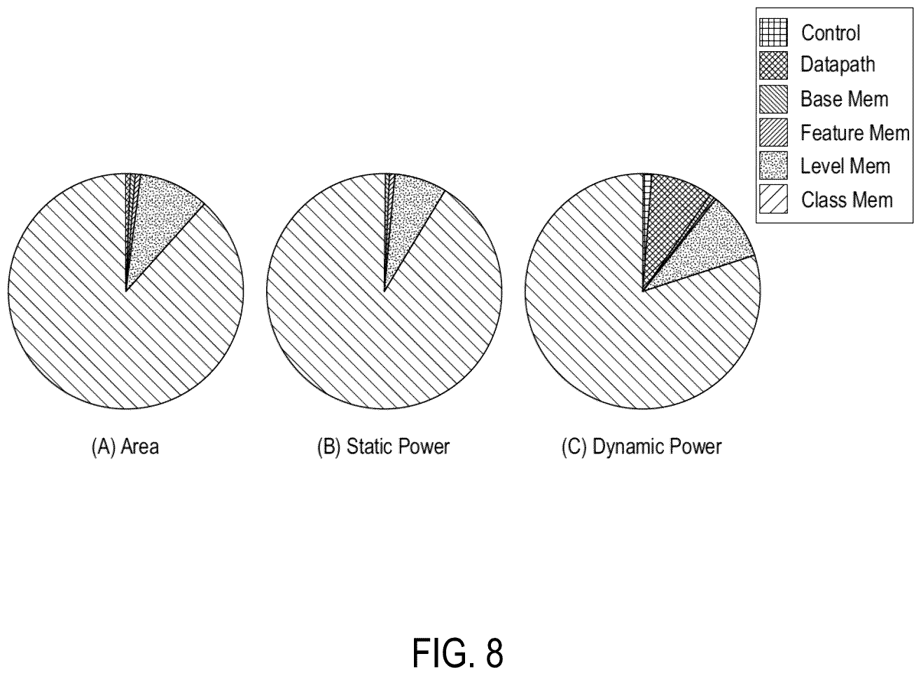

FIG. 8 provides a breakdown of the area and power consumption of the ASIC accelerator system 500. Note that the level memory 530 contributes to less than 10% of area and power. Hence, using more levels does not considerably affect the area or power.

### Classification Evaluation

### Training

Since previous HDC ASICs have not reported training energy and performance, in this example, we compared the per-input energy and execution time of the ASIC accelerator system training with RF (random forest, most efficient baseline) and SVM (most accurate conventional ML) on CPU, and DNN and HDC on eGPU.

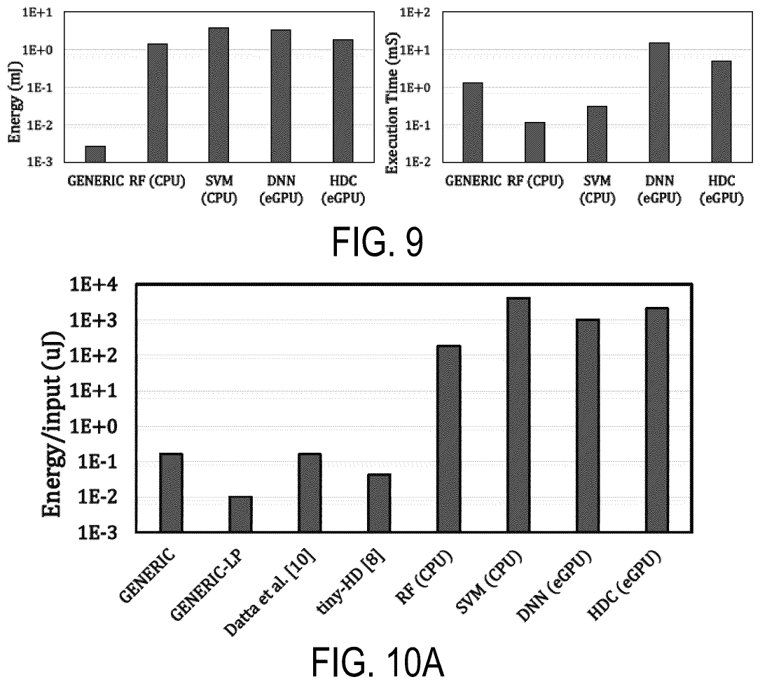

FIG. 9 compares the training energy and execution time of the ASIC accelerator system 500 with other methods. For example, FIG. 9 shows the average energy and execution time for the datasets described herein. The ASIC accelerator system 500 improves the energy consumption by 528× over RF, 1257× over DNN, and 694× over HDC on eGPU (which, as discussed in Section 3.3, is the most efficient baseline device for HDC). The ASIC accelerator system 500 consumes an average 2.06 mW of training power. The ASIC accelerator system 500 has 11× faster train time than DNN and 3.7× than HDC on eGPU. RF has 12× smaller train time than the ASIC accelerator system 500, but the overall energy consumption of the ASIC accelerator system 500 is significantly (528×) smaller than RF. Also, constant 20 epochs were used for the ASIC accelerator system training while the accuracy of most datasets saturates after a few epochs.

### Inference

We compare the energy consumption of the ASIC accelerator system inference with previous HDC platforms, and tiny-HD. We scale their report numbers to 14 nm for a fair comparison. We also include the RF (most efficient ML), SVM (most-accurate ML) and DNN on HDC on eGPU (most efficient HDC baseline).

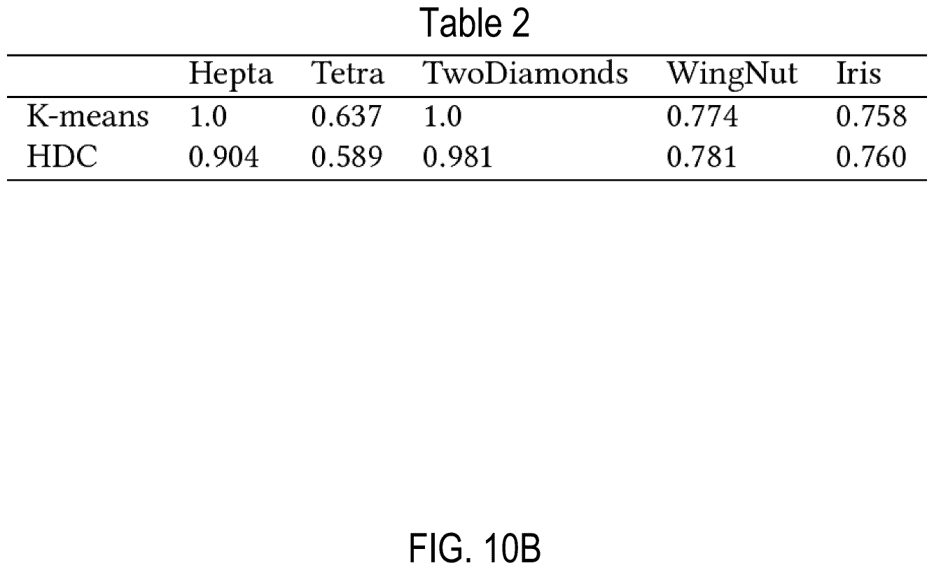

FIG. 10A compares the energy consumption of the ASIC accelerator system and aforementioned baselines. Since the ASIC accelerator system 500 achieves significantly higher accuracy than previous work, the ASIC accelerator system-LP applies the low-power techniques described herein to leverage this accuracy benefit. The ASIC accelerator system-LP improves the baseline system energy by 15.5× through dimension reduction and voltage over-scaling. The ASIC accelerator system-LP consumes 15.7× and 4.1× less energy compared to others. Note that despite tiny-HD, the ASIC accelerator system supports training which makes it to use larger memories. The ASIC accelerator system is 1593× and 8796× more energy-efficient than the most-efficient ML (RF) and eGPU-HDC, respectively.

### Clustering Evaluation

Table 2 compares the normalized mutual information score of the K-means and HDC for the FCPS benchmarks and the Iris flower dataset. On average, K-means achieves slightly (0.031) higher score, but for datasets with more features, the disclosed ASIC accelerator system can better benefit from using windows (windows become less effective in a smaller number of features).

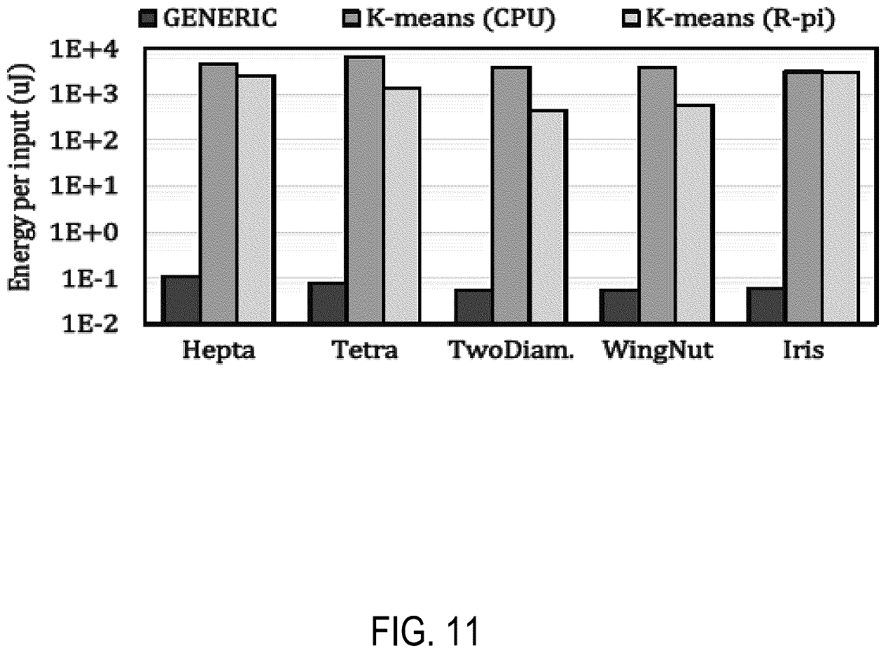

FIG. 11 compares the per-input energy consumption of the ASIC accelerator system with K-means clustering running on CPU and Raspberry Pi. The ASIC accelerator system 500 consumes only 0.068 μJ per input, which is 17,523× and 61,400× more efficient than K-means on Raspberry Pi and CPU. The average per-input execution time of Raspberry Pi and CPU is, respectively, 394 μSec and 248 μSec, while the ASIC accelerator system 500 achieves 9.6 μSec (41× and 26× faster than R-Pi and CPU, respectively).

Disclosed herein is an ASIC accelerator system, a highly-efficient HDC accelerator that supports classification (inference and training) and clustering using a novel encoding technique that achieves 3.5% (6.5%) better accuracy compared to other HDC (ML) algorithms. The ASIC accelerator system 500 benefits from power-gating, voltage over-scaling, and dimension reduction for utmost energy saving. The result described herein shows that the ASIC accelerator system 500 improves the classification energy by 15.1× over a previous trainable HDC accelerator, and 4.1× over an inference-only accelerator. The ASIC accelerator system HDC-based clustering consumes 17,523× lower energy with 41× higher performance than Raspberry Pi running K-means with similar accuracy, facilitating ultra-efficient continuous learning on edge.

### Enhancing Deep Neural Network Efficiency Through Patterned Filter Clustering and Computation Reuse

The ever-increasing efficacy of Deep Neural Networks (DNNs) in diverse application domains is coupled with the increase in the size and computations of their models. Extensive research has been done to alleviate the memory and computational burden of DNNs. Primary compression techniques include weight quantization, pruning, clustering, and filter pruning, especially with a slant toward hardware efficiency such as hardware-aware quantization and structured pruning.

In weight quantization, the network parameters take values from a set of predetermined values (e.g., −2^{k-1} to 2^{k-1}−1 in uniform quantization), while weight clustering groups the weights into abstract clusters, where all weights of a cluster share the same value. Thus, by clustering, one can store the cluster index/id of each weight (in index table), along with a small table that maps the indexes to weight values. Previous works show that ˜16 unique weights can retain the accuracy, which results in 2× memory compression by storing log₂ 16=4-bit indexes instead of the primary 8-bit weights.

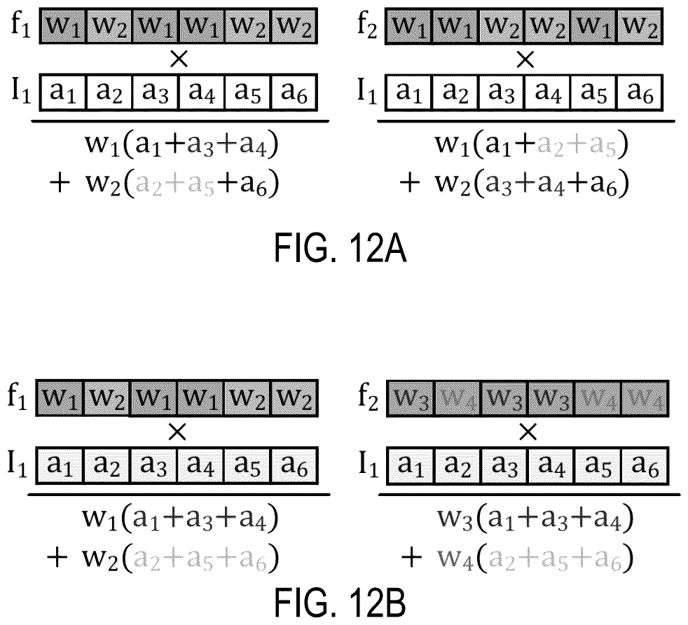

FIGS. 12A and 12b illustrate an example convolution operation in CNNs. FIG. 12A illustrates filter clustering with two unique weights to demonstrate the reduction of multiplication operations through input accumulation based on weight clusters. FIG. 12B illustrates filters sharing the same clustering pattern, highlighting memory and computation reduction by reusing cluster-index information and input sub-groups. As shown, the convolution operation in CNNs is essentially a window-wise dot-product between a multi-dimensional filter and the input activations to generate output feature maps. Since clustering uses a limited number of unique weights, it can be leveraged for computation efficiency by factorizing weights. The example of FIG. 12A shows filters clustered with two unique weights w₁ and w₂. Clustering can reduce multiplications (MULs) by first accumulating the inputs based on the weights clusters and applying MULs on the sum of factorized terms. For a filter with nw weights (typically O(10³)), the number of MULs reduces from nw to G (the number of unique weights or clusters), where usually G=16 unique weights is sufficient as alluded earlier. Factorization also results in common sub-groups of inputs. In FIG. 12A, both filters f₁ and f₂ computations have overlapping sub-groups a₃+a₄ and a₂+a₅.

Described herein are techniques for enhancing computation reuse and minimize memory usage through the implementation of shared clustering patterns among filters. Filters f₁ and f₂ in FIG. 12B share the same clustering. That is, a particular weight at index i of both f₁ and f₂ belong to the same cluster. This is distinguished by using the same background colors for clusters of f₁ and f₂. However, unlike baseline clustering that uses the same unique weights, in the disclosed pattern clustering system each filter can have a different set of G unique weights; hence, filters share clustering patterns, not exact data. As a result of pattern sharing, along with the reuse of whole activation groups between f₁ and f₂ (e.g., a₁+a₃+a₄ is repeated for both filters), the same cluster-index information can be used for both filters. Therefore, f₂ only needs to store its unique weights set (which is negligible compared to the eliminated index information) and carry out only G MULs on the pre-computed input sub-groups that have already been accumulated when processing f₁.

Described herein, the potentials of patterned filters are explored, introducing a mathematical formulation to identify the patterns and a training strategy to enforce these patterns while maintaining model accuracy. Such an approach represents a novel contribution to the field, marking the introduction of patterned filters to save memory and computation of DNNs. Furthermore, as described herein, discussion includes the dataflow, architecture, and processing units of the pattern clustering system accelerator, designed to support networks utilizing both patterned and conventional weight clustering. Given that weight quantization is a form of clustering, the architecture can also be compatible with quantized networks. The efficiency of the pattern clustering system is evaluated across various datasets and networks, focusing on computation and memory reduction, and comparisons are made with previously established works.

### Patterned Neural Network

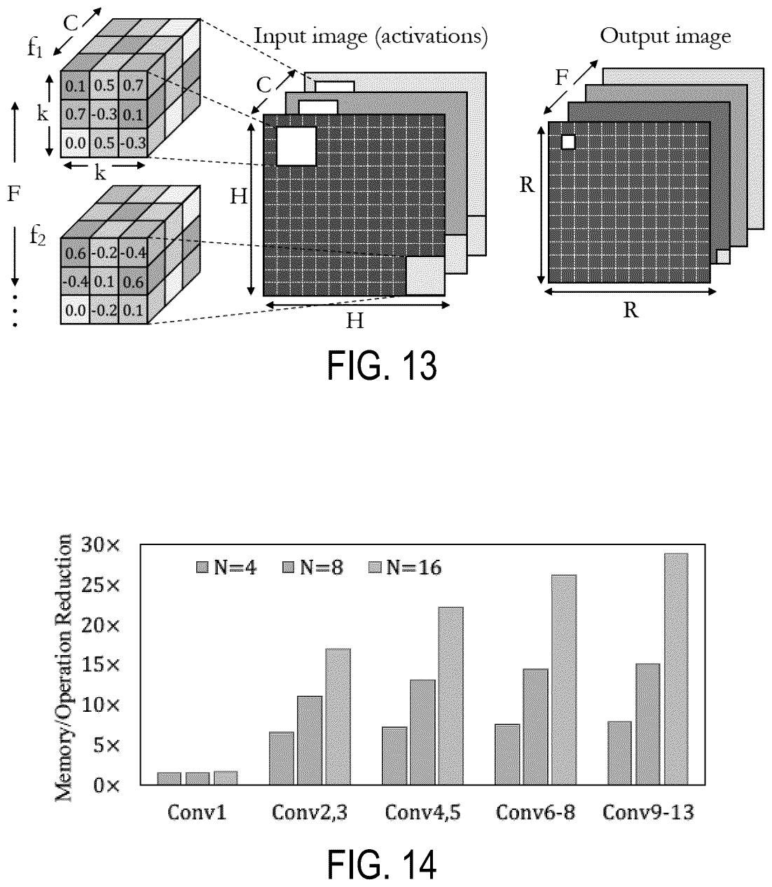

FIG. 13 shows the parameters of a convolution layer that comprises F filters of C×k×k dimension. The depth of each filter, C, is equal to the number of channels (feature maps) of the input activations. An output pixel (activation) of output channel [symbol] is created by applying the filter Ft over a particular C×k×k window of the input. Thus, the number of output feature maps is equal to the number of filters, F. Multiplication of a filter and input window is essentially a dot-product by flattening them. For an input with H×H channels, the output image has a dimension of R×R, for

$$R = \frac{H - k}{S} + 1 ,$$

where S is the stride size (i.e., the sliding step of the filters).

Assuming every n_{f} subset of a layer's filters share the same clustering pattern, the total parameter memory consists of C×k×k×log G bits to store the common index table (i.e., cluster indexes of weights instead of values), and n_{f}×G×8b bits to store the actual weights of n_{f} filters assuming 8-bit weights. The total number of operations include total C×k×k ADD (in G groups/clusters), accompanied with G MULs and ADDs for each filter to generate an output.

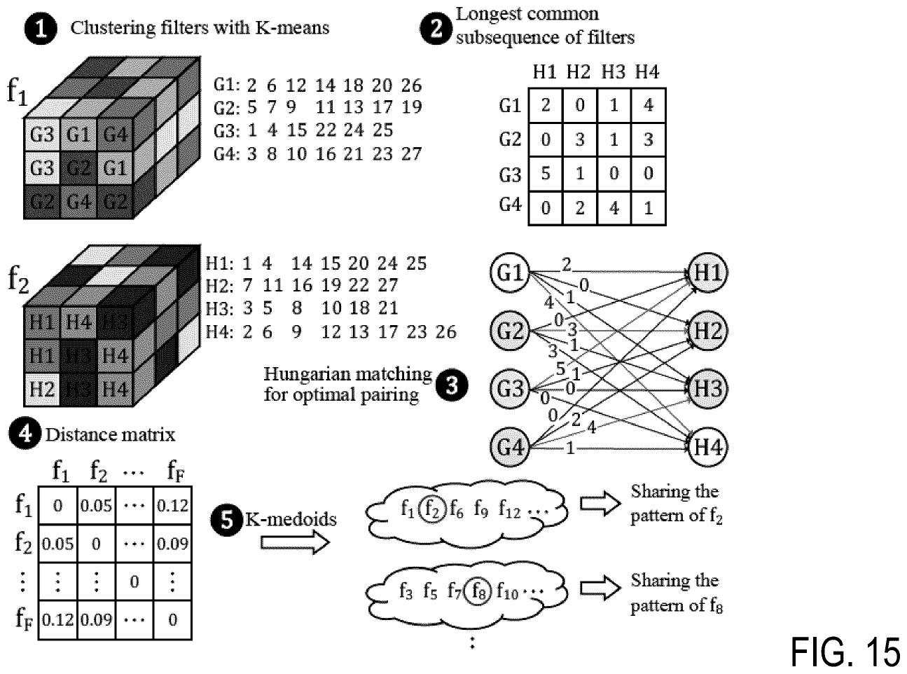

FIG. 14 shows the parameter memory and operation reduction of patterned VGG-16 layers over the 8-bit quantized model for N∈{4, 8, 16} filters sharing one pattern assuming G=16 unique weights per filter. For intermediate layers, saving ranges from 7.2× to 22.1× depending on N, and up to 28.8× in the last layers. It was assumed that a fixed number of filters share a single pattern. In practice, each pattern may contribute to a different number of filters of a layer. Note that G=16 and 8-bit weights are a special case that leads to the same memory and operation savings; otherwise, the savings can be different.

### Pattern Selection

Pattern selection can include determining the number of clustering patterns, the patterns themselves, and the assignment of patterns to filters. Exploring inter-filter structural similarities is a proper starting point in determining the common patterns and the filters that share these patterns. Patterning is more complicated than other problems such as filter pruning that considers the filters exclusively (e.g., pruning based on l1 norms or ranks of filters).

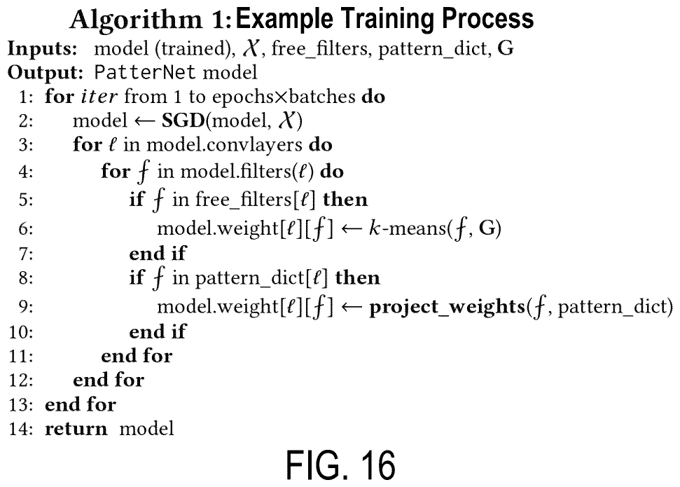

FIG. 15 illustrates an example pattern selection process, displaying filter weight clustering into groups for similar pattern assignment. FIG. 15 is used to elaborate the disclosed pattern selection approach. Using a pre-trained model, the weights of each filter are clustered to G groups using any conventional approach such as k-means. Note that this step is a simple one-shot clustering merely to reduce the number of unique weights of filters. In this illustrative example, filters f₁ and f₂ are clustered into four groups, distinguished by different colors. In patterned clustering, for flexibility, each filter can have an arbitrary set of unique weights different than other filters (denoted by G₁₋₄ for f₁ and H₁₋₄ for f₂ in FIG. 15). The goal is to find the filters with most similar clustering, indicated by how many same-cluster weight indexes in fᵢ are also in the same cluster in fⱼ. One approach is to correspond each cluster of fᵢ with a cluster in fⱼ and count the overlaps, which results in G! combinations (2×10¹³ for G=16).

We formulate the “similarity finding” as the Hungarian matching problem. For each pair of filters fᵢ and fⱼ, we create the table of longest common subsequences between all groups, ending up in a G×G table. For instance, in FIG. 15, cluster G₂ of f₁ has three common indexes with cluster H₄ of f₂, namely, indexes 2, 14, and 20. The Hungarian matching algorithm, with a time complexity of O(G³), finds the best matching of fi and fj groups that maximizes the score (shared elements). The example of FIG. 15 obtained a score of 20, meaning that by replacing clustering of f₁ with f₂, 20 (out of 27) weights of f₁ will be still in the same cluster as before (i.e., only 7 of f₁ weights get a different value).

We obtain the similarity scores between all pairs of filters and create an F×F distance matrix (distance defined as 1/score). Finally, we use the distance matrix to find P (number of patterns) collections of filters, where filters of a collection have smaller distances to each other than to other collections. For this end, we use the k-medoids algorithm to cluster F filters into P collections. Unlike k-means that calculates the Euclidean distance between data points, k-medoids works with custom cost functions, e.g., a distance matrix. In addition, unlike k-means, k-medoids returns actual data points of the collection as the center points, leading to a greater interpretability of the centers. This is essential in pattern selection as the returned centers will be the filters with their clustering pattern selected to be shared. Note that the number of filters in each of the P pattern collections can be different.

### Free Filters

Although imposing a limited number of patterns among all the filters works for simpler datasets such as Fashion-MNIST, in more complex datasets such as CIFAR100, there is often an accuracy degradation. This is a result of failing to extract certain pixel patterns because of the cluster-sharing constraint between the filters. Therefore, we relax the constraint of pattern sharing on certain filters in a layer, dubbed as free filters. Free filters still comply with weight clustering (hence they still benefit from factorization) but do not follow an enforced pattern.

To select the free filters, in the original pretrained model, we sort the filters based on the singular value decomposition (SVD) of their output feature maps using the train data. SVD value indicates how many rows of a feature map are linearly independent. The overall rank score of a filter is the mean of the generated feature maps SVDs. Filters with a rank higher than a threshold are deemed as more informative filters and selected as pattern-free (or indeed single-pattern) filters.

### Patterned Model Training

After identifying the patterns associated with each filter, we use projected gradient descent (PGD) to calibrate the model toward the determined patterns. PGD solves constrained optimization problems, which in this example is “the solution W of the DNN must belong to pattern constraints Q”, formally,

$${min}_{W ∈ Q} f ( {\{ {W}^{i} \}}_{i = 1}^{L} , X ) ,$$

where L is the layers and X is the input data. Starting from an initial W0 ∈Q (e.g., by cluster-wise averaging of pre-trained weights) PGD proceeds as follows:

$${W}_{k + 1} = {P}_{Q} ( {W}_{k} - λ▽ f ( {W}_{k} , X ) ) \qquad ( 3 )$$

P_{Q} projects the gradients such that Wₖ₊₁ ∈Q as well. The projection of the gradients itself is an optimization problem:

$${P}_{Q} ( {W}_{k} ) = arg {min}_{W ∈ Q} {\vert W - {W}_{k} \vert}_{2}^{2} \qquad ( 4 )$$

Meaning that the new weights need to minimize |W−Wₖ|₂² while also adhering to Q. Since weights of the solution W are clustered, i.e. all weights of a cluster get the same value, the solution of Equation (4) translates to minimizing Σ(x−wᵢ)² for each cluster, in which wᵢ s are the post-gradient weights and x is the new weight of the cluster. Thus, x=w̅ᵢ̅ yields the optimal solution. Therefore, after backpropagation of each batch, each updated weight can be replaced with the average of its cluster.

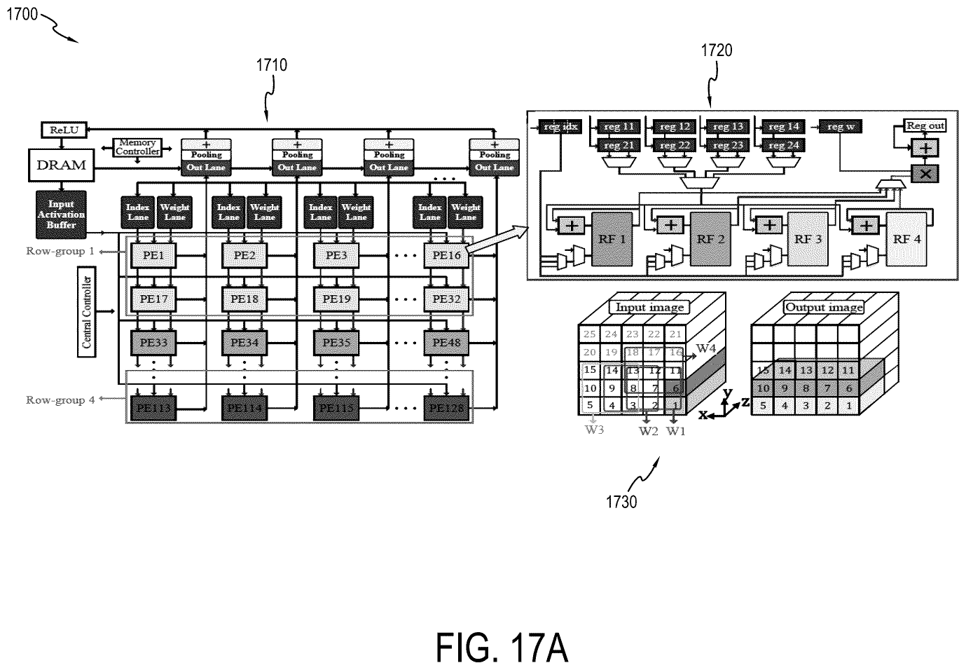

FIG. 16 illustrates an example algorithm (Algorithm 1) for an example training process in the pattern clustering system. Algorithm 1 summarizes the pattern clustering system training, where the project weights function of line 9 carries out the weight projection explained above.

### Example Architecture of the Pattern Clustering System

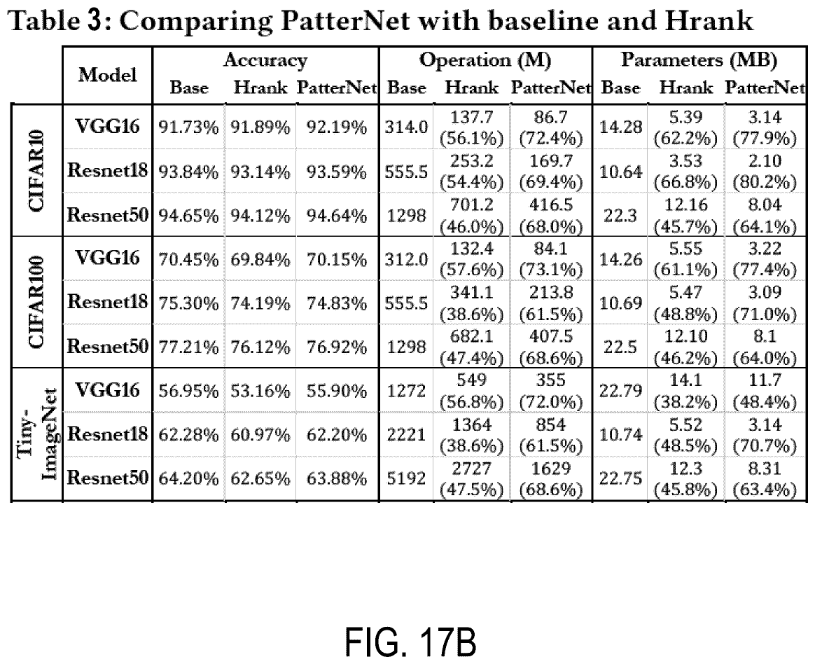

FIG. 17A illustrates an architecture of an example pattern clustering system 1700 and data flow. The system 1700 includes an Rₐ×Cₐ array of processing elements (PEs). Each PE is responsible for one pattern (which is shared with one or multiple filters) and generates one/multiple output pixels. PEs gradually receive all the inputs and pattern cluster indexes of a window, accumulate each input in the proper group based on the index, and eventually multiply the unique weights (for all filters sharing the pattern) on the accumulated groups.

To reduce the memory accesses, the pattern clustering system 1700 uses a pattern-stationary data flow while trying to maximize the data reuse, as well. To this end, the PE array is logically split into row-groups, made up of two consecutive rows (total Rₐ/2 row-groups in our architecture). All PEs in a row-group operate on the same inputs (intra row-group data sharing), but each PE possesses a different pattern. Thus, a row group generates multiple channels of an output. The corresponding PEs in all row-groups (e.g., PE₁, PE₃₃, etc.) possess the same pattern (inter row-group data sharing), but use different inputs. Therefore, in a given time, the same channels of Rₐ/2 outputs are on progress. Once all the channels associated with the running patterns are produced, the pattern clustering system 1700 scans another input window to generate the next Rₐ/2 outputs. After scanning all input rows, the pattern clustering system 1700 starts over with the next set of patterns (if any) and repeats the same procedure to generate all the channels.

### Data Flow

The data flow of the pattern clustering system 1700 can be elaborated using the 3×3 example convolution of FIG. 17. A brick is a complete 1×1 window that includes all the channels (z dimension). The pattern clustering system 1700 fetches the input activations as sub-bricks. The number of channels (pixels) in a sub-brick is architectural parameter (e.g., four pixels). As shown in FIG. 17A, the convolution involving the input activation window

$$w 1 = ( \begin{matrix}13 & 12 & 11 \\ 8 & 7 & 6 \\ 3 & 2 & 1\end{matrix} )$$

and the associated filter generates the right-most pixel of the output feature map. To do this, fetching of inputs starts from the bottom-right brick toward to top-left in a column-wise fashion (i.e., 1→6→ . . . 13) by fetching all sub-bricks commencing the next brick. This facilitates a great degree of data reuse. Once a sub-brick is fetched, it is broadcast to all PEs in a row-group. Along with the inputs, each PE receives the pattern index corresponding to the fetched activations.

To recap, we first create activation sub-groups by adding cluster specific activations, before multiplying with the cluster's weight value. To implement this, in every cycle, a PE processes one activation and adds it to the corresponding cluster group (out of G). After fetching and accumulating all the input bricks of an input window, each PE fetches the actual weights associated with the processed pattern. For each filter that shares the current pattern, the PE fetches its G unique weights cycle by cycle and multiplies with the accumulated values of group-1 to group-G. The aforementioned window w1 produces the output pixels associated with 32 patterns of PE₁ to PE₃₂ of output brick 1 (i.e., at least 32 channels of the output feature map). The convolution window is then shifted left. Hence, the row-group 1 will generate the same channels of output brick 2 as it did for output brick 1.

Multiple row-groups generate multiple output rows simultaneously. As row-group 1 processes input window w1, row-group 2 processes window w4 to generate 2nd output row. All row-groups generate the same channels since they use the same patterns (hence, filters). Once the row-groups finish scanning the current input rows (i.e., the windows reach the left edge), each input window moves up by Rₐ/2 (number of row-groups) rows. After scanning all the rows, the pattern clustering system 1700 starts over from the first row with a new set of patterns until all output channels are created.

### Data Reuse

The pattern clustering system 1700 can take advantage of multiple levels of data sharing. The input activations are shared among all PEs of a row-group, and clusters index data are shared between all corresponding PEs in the row-groups (e.g., PE₁, PE₃₃, PE₆₅, etc.). In addition, except the edge of the image, in a 3×3 convolution window, an input brick is shared between three windows of the same row. For example, in FIG. 17A, input brick 3 is used in windows w₁, w₂, and w₃ (processed by RF1, RF2, and RF3 as explained in the next subSection). Therefore, once a sub-brick of input brick 3 is fetched, the pattern clustering system's PE processes computations for all the three windows (the PE also fetches three index data in a cycle). This results in ˜3× speed-up in addition to memory access reduction. Furthermore, the kth row-group processes one input row ahead of its previous row-group k−1. The pattern clustering system 1700 buffers the input to be reused later for row-group k−1 and avoids DRAM accesses with a small buffer. For instance, row-group 2 starts by operating on input brick 6, which will be immediately required by row-group 1 upon finishing input brick 1. Similarly, row-group 3 starts by input brick 11, which will be required by row-group 2 after processing input brick 6. This efficient data reuse is possible due to the pattern clustering system's data flow that simultaneously runs multiple vertically-adjacent windows, and processing each window in a column-wise fashion. Thus, when scanning the input image for the current patterns, each input is fetched only once from the DRAM.

### Processing Units

Processing Elements: FIG. 17A shows the internals of the PE 1720. Top boxes are temporary registers reg11 to reg24 that store the activations sub-bricks fetched from the input buffer. PEs of different row-groups use the same input buffer bus in a time-multiplexed fashion. Thus, these registers are required to store enough inputs until the round-robin arbiter grants access to a row-group to fetch the next sub-brick after Rₐ/2 cycles.

Register Files: An input brick may participate in several adjacent windows. The register files RF1 to RF4 receive one input activation as data, along with several cluster indexes as the address to accumulate the input with the proper group. One of the RFs is spare to avoid stalls, explained below. The reg idx (index register) continuously fetches these index data from the Index Lane buffer. Since the windows sharing an input are adjacent (i.e., an activation only differs in x dimension within the windows), the index data of these windows can be aligned in one memory row. Note that since corresponding PEs of row-groups process the same pattern, the fetched index data is broadcast to all of Rₐ/2 corresponding PEs of all row-groups using the common index bus of a column.

Accumulator: Once all inputs of a window are accumulated in an RF, the PE loads unique weights w₁ to wG one-by-one from the Weight Lane to the reg w, and reads the accumulated sum of group-1 to group-G from that RF, accumulates the multiplications in the reg out, and finally transfers the output to Out Lane. Since each filter sharing a pattern has its own unique weights, these multiplications need to be repeated for all filters sharing the pattern. A benefit of the pattern clustering system 1700 is that, once the input sub-groups are computed a pattern, producing new output channels (of shared filters) takes just G cycles per filter. Since the first window (of horizontally adjacent windows) is several input bricks ahead from the other two, in a given time, the results of only one window becomes ready in a PE. A PE contains one extra RF, so when an RF is stuck to finalize the multiplications, the fourth RF replaces it to process new input bricks and avoid stall.

Output Lanes: PEs in a column time-multiplex the same output bus to transfer the output activation to the Out Lane. The bus is granted in a round-robin fashion, but it does not cause performance overhead as outputs of all PEs of a column can be transferred to Out Lane before generating the outputs of next window. The Out Lane temporarily stores a few adjacent horizontal outputs (from the same PE), or adjacent vertical outputs (from the corresponding PEs of different row-groups) for pooling operation before writing to DRAM. The output data layout written into the DRAM is the same as input bricks, i.e., continuous pixels of an output brick are written in the same DRAM row.

### Experiments and Results

The pattern clustering system concepts disclosed herein (e.g., pattern and rankbased free filter selection and training) were implemented using PyTorch. For training, SGD optimizer was used, momentum of 0.9 with weight decaying, and learning rate from 0.1 down to 0.0008 over 100 epochs. For parameter G (number of unique weights or clusters per pattern) we found G=16 sufficient to retain accuracy by sweeping across a spectrum of values. Similarly, we tried a range of values for P (number of patterns) and found P=16 sufficient for accuracy.

We implemented the pattern clustering system accelerator in SystemVerilog and verified its functionality with Modelsim. We synthesized it using TSMC 40 nm standard cell library at 0.9 V using Synopsys Design Compiler for a target frequency of 500 MHz. We used Artisan memory compiler with the same technology to generate SRAM buffers and register files. Power consumption of all elements is obtained using Synopsys Power Compiler. For DRAM access energy model, we used Destiny. Our primary architecture includes Rₐ=8 rows (four row-groups) and Cₐ=16 (32 PEs per row-group).

### Operation and Memory Reduction

We evaluate the effectiveness of the pattern clustering system 1700 by comparing it with a filter pruning approach dubbed Hrank. We use VGG16, Resnet18, and Resnet50 networks with CIFAR10 and CIFAR100 datasets, and a 200-class subset of ImageNet (Tiny ImageNet). The patterned filters run ADDs to accumulate the input activations for P filters, followed by MULs of their unique weights on the resulted groups. The free filters are special cases of patterned filters, where a free filter has one independent pattern. Thus, free filters also benefit from factorization to reduce the number of MULs, as well as weight clustering to reduce memory.

Table 3 summarizes the accuracy, operation count (ADD and MUL), and memory for the aforementioned models and datasets. The Base column indicates the baseline 8-bit model, and Hrank column is the filter pruning. We selected the pruning ratios of Hrank layers according to its original work.

CIFAR10: As compared to the baseline VGG16 network, while HRank provides 56.1% reduction in operation count and 62.2% reduction in parameters, the disclosed techniques offer 72.4% reduction in operation count and 77.9% reduction in parameters, with 0.3% better accuracy. For residual networks such as ResNet18, while the operation reduction in HRank is 54.4%, the disclosed techniques offer 69.4% reduction. We observe a similar trend for ResNet50; 68% operation reduction in the pattern clustering system 1700 as compared to 46% reduction of HRank. The pattern clustering system 1700 shrinks parameters size significantly (80.2% vs HRank's 66.8%) for Resnet18 and (64.1% vs HRank's 45.7%) for Resnet50, along with better accuracy metrics as compared to HRank.

CIFAR100: For CIFAR100, we achieve 73.1% operation count reduction using VGG16, 61.5% using ResNet18 and 68.6% using ResNet50. The reduction in parameters is considerably better than HRank's reductions (77.4% vs 61.1%, 71% vs 48.8% and 64% vs 46.2%) for VGG16, ResNet18 and ResNet50 respectively.

TinyImageNet: We observe a similar trend with the Tiny ImageNet dataset. Along with an improved operation reduction (up to 72%) and parameter reduction (up to 70.7%) as compared to the baseline, the improvements disclosed herein are better than HRank while achieving improved accuracy metrics (1-2%) over HRank.

In summary, among other things, the pattern clustering system 1700 shrinks the model memory up to 80.2% and operation count up to 73.1%, with a similar accuracy as compared to the 8-bit baseline models.

### The Pattern Clustering System Accelerator

The architecture of the pattern clustering system 1700 can include four row-groups (Rₐ=8) and 16 columns (Cₐ=16). Table 4 reports the size of the pattern clustering system memories. The input buffer stores the entire brick of a row-group for reuse by the preceding row-group. The image depth goes up to 2048 channels in Resnet50, thus, the input buffer should store 2048×4 input activations of four row-groups, packed as 2048×32b (four inputs of a brick are packed in a row and fetched at once to a row-group). The index memory stores all 4-bit indexes, which is 512×3×3 for the largest filter. Since three indexes per pattern is read in a column (and there are two patterns in a column), the memory has a 768×(6×4) layout. The weight memory supplies the unique weights of a column's filters. Each pattern is shared with up to 32 filters; thus, it stores up to 64 weights. Similarly, the out lane stores all outputs generated by a column (four row-groups and 64 filters). In addition, it stores the adjacent pixels for pooling, requiring a total of 512 rows and 20-bit per row for each output pixel. Finally, each RF has 16 rows for accumulation of G=16 groups.

Table 5 shows the per-component area and delay of the pattern clustering system 1700. The 8×16 architecture of the pattern clustering system 1700 occupies an area of 1.84 mm² (at 40 nm). The compact area is mainly due to sharing a weight index lane and an output lane within an entire column, and a small input activation memory that buffers the inputs for reuse so the pattern clustering system 1700 uses only 70 KB on-chip memory. The design consumes a peak (worst-case) power of 145.7 mW: 29.4 mW leakage, and maximum dynamic power of 116.3 mW (at 500 MHz), 34% of which is the DRAM access power. The data reuse of the pattern clustering system 1700 makes an effective DRAM access rate of ˜1 Byte/cycle, the same rate as PEs consume inputs in a shared fashion.

### Scalability of the Pattern Clustering System

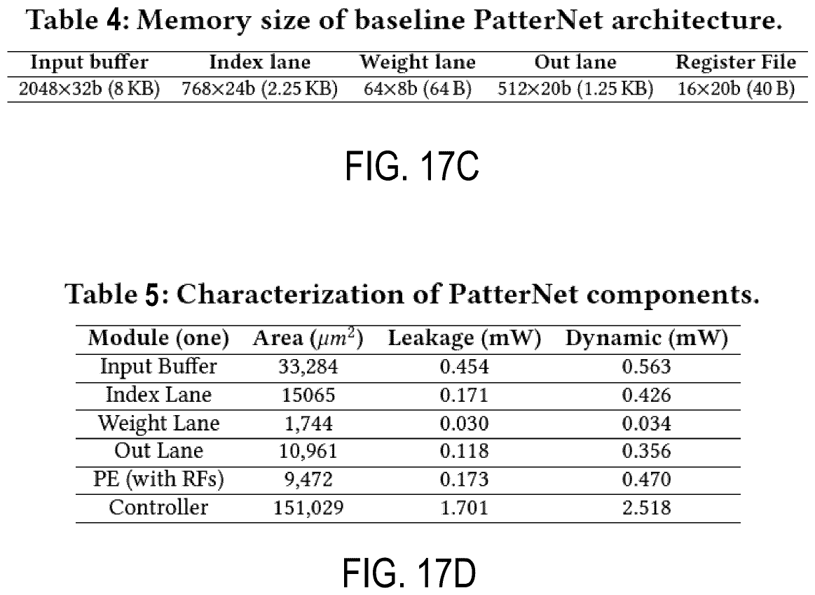

FIGS. 18A and 18B show the scalability of the pattern clustering system (implementing VGG16 model) as the array size increases from 8×16 to 8×32 (2× columns), 16×16 (2× rows), and 16×32 (2× columns and rows) for 32×32 images and ImageNet-scale 224×224 images. The area in both cases is the same and input-independent. Except for the PE utilization that shows the actual quantities, the other parameters are normalized to 8×16 array values (Table 4 shows the actual values of the baseline 8×16 architecture). For large images, the pattern clustering system architecture shows better scalability, i.e., 3.6× higher performance (input/sec) when both rows and columns duplicate. However, for small images, PE utilization rate reduces down to 46% in the 16×32 array. As a result, it achieves only 2.6× performance gain. The average utilization rate for large images is 90% in the baseline 8×16 array and 76% in the largest array. The area is not scaled by 4× since the size of index lane and weight lane buffers remains the same, and their number only increases by 2×. Finally, for large images, the largest array (16×32) shows better energy/input. This can be mainly because the DRAM access power ratio significantly reduces (down to 9.3%) because the fetched inputs are reused between more row-groups.

Comparison with Previous Work

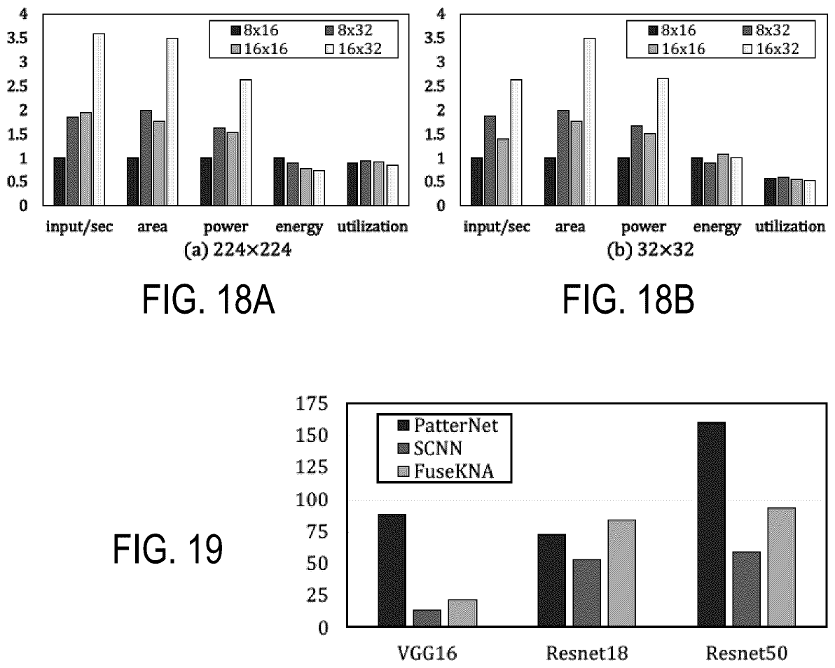

FIG. 19 illustrates the energy efficiency of the pattern clustering system compared with other architectures, illustrating superior performance-per-watt in image processing.

We compare performance-per-watt of the pattern clustering system with the FuseKNA, which also reuses the overlapping ADDs among kernels in a bit-serial accelerator, and with SCNN, which is a MAC-based sparse (zero-skipping) accelerator (results compiled from [13]). FIG. 19 shows the performance-per-watt (energy per image) normalized to Nvidia 1080 GTX GPU, all designs running 224×224 images. The pattern clustering system surpasses GPU energy efficiency by 107×, SCNN by 3.6×, and FuseKNA by 2.2×.

Described herein, the introduction of the concept of patterned cluster sharing among DNN filters is highlighted, demonstrating significant advancements in memory and operation efficiency through the reuse of clustering indexes and weight factorization. Techniques for the determination and assignment of patterns across filters, coupled with a strategic training approach to achieve desired patterns, are elaborated. The effectiveness of filter patterning was assessed using a variety of datasets and networks, showcasing substantial reductions in memory and operational demands, with improvements exceeding traditional filter pruning methods in terms of both efficiency and accuracy. Furthermore, the development of the pattern clustering system accelerator, embodying the principles discussed, is revealed to have achieved enhanced energy efficiency, outperforming contemporary accelerators by a notable margin.

### EXAMPLE EMBODIMENTS

Various examples of methods and systems for selectively communicating medication data field values to a patient information system can be found in the following clauses:

Clause 1. A method for encoding within a hyperdimensional computing framework, comprising:

obtaining data to be encoded;

segmenting the obtained data into a plurality of windows, wherein each window of the plurality of windows comprises a sequence of data elements;

for each window of the plurality of overlapping window:
for each data element within a particular window, selecting a level hypervector from a set of level hypervectors, wherein each level hypervector of the set of level hypervectors represents a quantized value of the respective data element in high-dimensional space,
for each selected level hypervector, applying a permutation operation to the respective selected level hypervector based on a sequential position of a corresponding data element within the window, wherein the applying results in a set of permuted level hypervectors for the particular window,
performing a binary operation on the set of permuted level hypervectors to generate a window hypervector that that represents the sequence of data elements for that particular window; and

aggregating the window hypervectors for each window of the plurality of windows to generate an encoded hypervector, wherein the encoded hypervector is representative of obtained data in a hyperdimensional vector space.

Clause 2. The method of clause 1, wherein the obtained data comprises at least one of textual data, image data, voice data, or sensor data.

Clause 3. The method of clause 1, wherein the binary operation executed on the set of permuted level hypervectors is an exclusive OR (XOR) operation.

Clause 4. The method of clause 1, wherein the permutation operation applied to each selected level hypervector is based on a predetermined number of positions reflective of an order of the sequence of data elements within the particular window.

Clause 5. The method of clause 1, wherein the set of level hypervectors is predefined, each representing a distinct quantized value corresponding to possible values of data elements.

Clause 6. The method of clause 1, further comprising associating each window hypervector with a unique identifier hypervector through an XOR operation to incorporate global sequence information into the encoding.

Clause 7. The method of clause 6, wherein decoding the encoded hypervector includes utilizing the unique identifier hypervector to reconstruct the sequence of data elements from the encoded hypervector based on the global sequence information encoded by the unique identifiers.

Clause 8. The method of clause 1, wherein aggregating the window hypervectors includes a weighted aggregation based on a predetermined importance criterion assigned to each window.

Clause 9. The method of clause 1, further comprising normalizing the aggregated encoded hypervector to obtain a uniform vector magnitude across different instances of encoded data.

Clause 10. The method of clause 1, wherein adjacent windows of the plurality of windows have a shared subset of data elements at their interface so as to define an overlap of one or more final data elements from a first window and one or more beginning data elements of a subsequent window.

Clause 11. The method of clause 10, wherein a size of an overlapping portion between consecutive windows is adjusted according to a predetermined criterion related to sequential dependencies inherent in the obtained data.

Clause 12. Non-transitory physical computer storage comprising computer-executable instructions stored thereon that, when executed by one or more processors of a mobile device, are configured to implement a process comprising:

obtaining data to be encoded;

segmenting the obtained data into a plurality of windows, wherein each window of the plurality of windows comprises a sequence of data elements;

for each window of the plurality of overlapping window:

for each data element within a particular window, selecting a level hypervector from a set of level hypervectors, wherein each level hypervector of the set of level hypervectors represents a quantized value of the respective data element in high-dimensional space,

for each selected level hypervector, applying a permutation operation to the respective selected level hypervector based on a sequential position of a corresponding data element within the window, wherein the applying results in a set of permuted level hypervectors for the particular window,

performing a binary operation on the set of permuted level hypervectors to generate a window hypervector that that represents the sequence of data elements for that particular window; and

aggregating the window hypervectors for each window of the plurality of windows to generate an encoded hypervector, wherein the encoded hypervector is representative of obtained data in a hyperdimensional vector space.

Clause 13. An ASIC accelerator system for hyperdimensional computing (HDC) encoding, comprising:

a processor configured to:

receive data to be encoded via an input interface;

segment the received data into a plurality of windows, each comprising a sequence of data elements;

select, for each data element within a window, a corresponding level hypervector from a stored set of level hypervectors, where each level hypervector represents a quantized value of the data element in high-dimensional space;

apply permutation operations to each selected level hypervector based on its sequential position within the window to generate a set of permuted level hypervectors;

execute a binary operation on the set of permuted level hypervectors to produce a window hypervector representing the sequence of data elements for that window;

aggregate the window hypervectors from each window to generate an encoded hypervector, representative of the obtained data in a hyperdimensional vector space; and

output the encoded hypervector via an output interface.

Clause 14. The system of clause 12, further comprising a memory module communicatively coupled to the processor, wherein the memory module stores the set of level hypervectors.

Clause 15. The system of clause 12, further comprising computer-readable instructions stored on a non-transitory computer-readable medium, wherein the instructions, when executed by the processor, cause the processor to perform the tasks of receiving the data; segmenting the received data; selecting the corresponding level hypervector; applying permutation operations; executing the binary operation; aggregating the window hypervectors; and outputting the encoded hypervector.

Clause 16. The system of clause 12, wherein the received data comprises at least one of textual data, image data, voice data, or sensor data.

Clause 17. The system of clause 12, wherein the binary operation executed on the set of permuted level hypervectors is an exclusive OR (XOR) operation.

Clause 18. An ASIC accelerator system for hyperdimensional computing (HDC) encoding, comprising:

an input interface for receiving data to be encoded;

a data segmentation unit configured to segment the received data into a plurality of windows, each window comprising a sequence of data elements;

a level hypervector selection unit configured to select, for each data element within a window, a corresponding level hypervector from a set of level hypervectors stored in a level hypervector memory, wherein each level hypervector represents a quantized value of the data element in high-dimensional space;

a permutation unit configured to apply permutation operations to each selected level hypervector based on its sequential position within the window, resulting in a set of permuted level hypervectors for that window;

a binary operation unit configured to perform a binary operation on the set of permuted level hypervectors to produce a window hypervector representing the sequence of data elements for that window; and

an aggregation unit configured to aggregate the window hypervectors from each window to generate an encoded hypervector, representative of the obtained data in a hyperdimensional vector space.

Clause 19. The system of clause 18, further comprising:

an output interface configured to output the encoded hypervector;

a level hypervector memory for storing the set of level hypervectors; and

an identifier hypervector memory for storing identifier hypervectors used in associating window hypervectors with unique identifiers.

Clause 20. The system of clause 18, wherein at least one of the data segmentation unit, the level hypervector selection unit, the permutation unit, the binary operation unit, or the aggregation unit is implemented by at least one processor configured to execute instructions for performing respective functions of that unit.

Clause 21. The system of clause 18, wherein adjacent windows of the plurality of windows have a shared subset of data elements at their interface so as to define an overlap of one or more final data elements from a first window and one or more beginning data elements of a subsequent window.

Clause 22. A method for enhancing computational efficiency in Deep Neural Networks (DNNs) through use of shared clustering patterns, the method comprising:

establishing a plurality of shared clustering patterns across a plurality of filters within DNNs, each filter having a unique set of weights and being associated with at least one of the shared clustering patterns to facilitate computation reuse and memory efficiency; and

iteratively adjusting the weights of the filters to enforce the shared clustering patterns, thereby reducing computational load and memory requirements during operation of the DNNs.

Clause 23. The method of clause 22, further comprising:

identifying activation groups processed by a first filter of a plurality of filters within the DNNs, each filter associated with at least one shared clustering pattern; and

applying the identified activation groups to at least one subsequent filter within the plurality of filters that is associated with an identical shared clustering pattern as the first filter, thereby reusing activation groups across the plurality of filters.

Clause 24. The method of clause 23, wherein no additional computational operations are required for processing similar activation patterns across different filters within the plurality of filters due to reuse of activation groups.

Clause 25. The method of clause 23, wherein the reusing activation groups leads to a reduction in a total number of computational operations required by the DNNs and enhances an operational efficiency of the DNNs by eliminating computational redundancy incurred in processing similar activation patterns across different filters of the plurality of filters.

Clause 26. The method of clause 22, wherein establishing the plurality of shared clustering patterns includes analyzing structural characteristics of the filters to determine pattern similarities and variances, utilizing a clustering algorithm to categorize the filters based on their operational similarities.

Clause 27. The method of clause 22, further comprising generating shared cluster-index information for the plurality of filters to minimize multiplication operations by leveraging pre-computed activations common to filters associated with the same clustering pattern.

Clause 28. The method of clause 22, wherein iteratively adjusting the weights involves applying a targeted training strategy, the targeted training strategy incorporating backpropagation and gradient descent techniques to align the weights with the shared clustering patterns.

Clause 29. The method of clause 28, wherein the targeted training strategy includes employing projected gradient descent to ensure the weights of the filters conform to the shared clustering patterns while maintaining or improving an accuracy of the DNNs.

Clause 30. The method of clause 22, further comprising analyzing a performance of the DNNs before and after enforcement of the shared clustering patterns to quantify improvements in computational efficiency and memory usage.

Clause 31. The method of clause 30, further comprising optimizing the shared clustering patterns based on the analyzing to further enhance the computational efficiency and memory usage of the DNNs, wherein the optimizing includes selecting optimal clustering patterns that maximize computation reuse while minimizing memory footprint.

Clause 32. The method of clause 31, further comprising applying the optimized shared clustering patterns to the plurality of filters in a deployment phase of the DNNs, ensuring that the computational efficiency and memory usage improvements are realized in actual operating conditions.

Clause 33. The method of clause 22, further comprising generating a mapping of input activations to the shared clustering patterns, the mapping facilitating efficient computation by identifying common activations across the plurality of filters and reducing redundant computations.

Clause 34. The method of clause 22, further comprising employing a gradient descent algorithm to iteratively refine the weights of the filters in accordance with the shared clustering patterns, the refinement being guided by an objective function that quantifies a performance of the DNNs.

Clause 35. Non-transitory physical computer storage comprising computer-executable instructions stored thereon that, when executed by one or more processors of a mobile device, are configured to implement a process comprising:

establishing a plurality of shared clustering patterns across a plurality of filters within DNNs, each filter having a unique set of weights and being associated with at least one of the shared clustering patterns to facilitate computation reuse and memory efficiency; and

iteratively adjusting the weights of the filters to enforce the shared clustering patterns, thereby reducing computational load and memory requirements during operation of the DNNs.

Clause 36. A non-transitory computer-readable storage medium storing computer-executable instructions that, when executed by one or more processors, cause the one or more processors to:

receive data representing a plurality of filters within deep neural networks (DNNs), each filter having a unique set of weights;

establish shared clustering patterns across the plurality of filters by associating each filter with at least one shared clustering pattern to facilitate computation reuse and enhance memory efficiency; and

iteratively adjust the weights of the filters based on the established shared clustering patterns to reduce computational load and memory requirements during operation of the DNNs.

Clause 37. The non-transitory computer-readable storage medium of clause 36, wherein the computer-executable instructions further cause the one or more processors to:

identify activation groups processed by a first filter within the plurality of filters, each associated with at least one shared clustering pattern;

apply the identified activation groups to at least one subsequent filter within the plurality of filters that shares the identical clustering pattern with the first filter, thereby reusing activation groups across the filters.

Clause 38. The non-transitory computer-readable storage medium of clause 36, wherein the reuse of activation groups eliminates the need for additional computational operations for processing similar activation patterns across different filters within the plurality, leading to a reduction in a total number of computational operations required by the DNNs.

Clause 39. A system for enhancing efficiency in deep neural networks (DNNs) through implementation of shared clustering patterns, the system comprising:

one or more processors; and

a non-transitory computer-readable medium communicatively coupled to the one or more processors, the non-transitory computer-readable medium having stored thereon instructions that, when executed by the one or more processors, configure the system to:

establish shared clustering patterns across a plurality of filters within the DNNs, wherein each filter comprises a unique set of weights and is associated with at least one of the shared clustering patterns to facilitate computation reuse and reduce memory usage; and

iteratively adjust the weights of the filters in accordance with the established shared clustering patterns to decrease computational load and memory demands during operation of the DNNs.

Clause 40. The system of clause 39, wherein the computer-executable instructions further cause the one or more processors to:

identify activation groups processed by a first filter and apply the activation groups to at least one subsequent filter sharing an identical clustering pattern, thereby enabling reuse of activation groups across the filters to decrease a total number of computational operations required by the DNNs.

Clause 41. The system of clause 39, wherein the computer-executable instructions further cause the one or more processors to:

implement an index table that maps cluster indexes of weights in lieu of actual weight values, and a weight table for storing the unique weight set for each filter, thereby reducing storage requirements for cluster-index information; and

assign clustering patterns to filters based on structural similarities through mathematical formulations and algorithms.

Clause 42. The system of clause 39, wherein the computer-executable instructions further cause the one or more processors to:

employ projected gradient descent (PGD) to calibrate a model in alignment with the shared clustering patterns, ensuring adherence to pattern constraints with reduced deviation from initial weight configurations; and

facilitate efficient execution of the pattern clustering system through an accelerator architecture that comprises processing units, register files, accumulators, and output lanes, designed to facilitate efficient data processing and reduced memory access.

### Terminology

Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present.

Conditional language, such as, among others, “can,” “could,” “might,” or “can,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above detailed description using the singular or plural number can also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Depending on the embodiment, certain operations, acts, events, or functions of any of the algorithms described herein can be performed in a different sequence, can be added, merged, or left out altogether (for example, not all are necessary for the practice of the algorithms). Moreover, in certain embodiments, operations, acts, functions, or events can be performed concurrently, for example, through multi-threaded processing, interrupt processing, or multiple processors or processor cores or on other parallel architectures, rather than sequentially.

Systems and modules described herein can comprise software, firmware, hardware, or any combination(s) of software, firmware, or hardware suitable for the purposes described herein. Software and other modules can reside and execute on servers, workstations, personal computers, computerized tablets, PDAs, and other computing devices suitable for the purposes described herein. Software and other modules can be accessible via local memory, via a network, via a browser, or via other means suitable for the purposes described herein. Data structures described herein can comprise computer files, variables, programming arrays, programming structures, or any electronic information storage schemes or methods, or any combinations thereof, suitable for the purposes described herein. User interface elements described herein can comprise elements from graphical user interfaces, interactive voice response, command line interfaces, and other suitable interfaces.

Further, the processing of the various components of the illustrated systems can be distributed across multiple machines, networks, and other computing resources. In addition, two or more components of a system can be combined into fewer components. Various components of the illustrated systems can be implemented in one or more virtual machines, rather than in dedicated computer hardware systems and/or computing devices. Likewise, the data storage devices shown can represent physical and/or logical data storage, including, for example, storage area networks or other distributed storage systems. Moreover, the connections between the components shown can represent possible paths of data flow, rather than actual connections between hardware. While some examples of possible connections are shown, any of the subset of the components shown can communicate with any other subset of components in various implementations.

Embodiments are also described above with reference to flow chart illustrations and/or block diagrams of methods, apparatus (systems) and computer program products. Each block of the flow chart illustrations and/or block diagrams, and combinations of blocks in the flow chart illustrations and/or block diagrams, can be implemented by computer program instructions. Such instructions can be provided to a processor of a general purpose computer, special purpose computer, specially-equipped computer (for example, comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks.

These computer program instructions can also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions can also be loaded onto a computing device or other programmable data processing apparatus to cause a series of operations to be performed on the computing device or other programmable apparatus to produce a computer implemented process such that the instructions which execute on the computer or other programmable apparatus provide steps for implementing the acts specified in the flow chart and/or block diagram block or blocks.

Any patents and applications and other references noted above, including any that can be listed in accompanying filing papers, are incorporated herein by reference. Aspects of the disclosure can be modified, if necessary, to employ the systems, functions, and concepts of the various references described above to provide yet further implementations of the disclosure.

These and other changes can be made in light of the above detailed description. While the above description describes certain examples of the disclosure, and describes the best mode contemplated, no matter how detailed the above appears in text, the disclosure can be practiced in many ways. Details of the system can vary considerably in its specific implementation, while still being encompassed by the disclosure disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific examples disclosed in the specification, unless the above detailed description section explicitly defines such terms. Accordingly, the actual scope of the disclosure encompasses not only the disclosed examples, but also all equivalent ways of practicing or implementing the disclosure under the claims.

1. A method for encoding within a hyperdimensional computing framework, comprising:
obtaining data to be encoded;
segmenting the obtained data into a plurality of windows, wherein each window of the plurality of windows comprises a sequence of data elements;
for each window of the plurality of windows:
for each data element within a particular window, selecting a level hypervector from a set of level hypervectors, wherein each level hypervector of the set of level hypervectors represents a quantized value of the respective data element in high-dimensional space,
for each selected level hypervector, applying a permutation operation to the respective selected level hypervector based on a sequential position of a corresponding data element within the window, wherein the applying results in a set of permuted level hypervectors for the particular window,
performing a binary operation on the set of permuted level hypervectors to generate a window hypervector that that represents the sequence of data elements for that particular window; and
aggregating the window hypervectors for each window of the plurality of windows to generate an encoded hypervector, wherein the encoded hypervector is representative of obtained data in a hyperdimensional vector space.

2. The method of claim 1, wherein the obtained data comprises at least one of textual data, image data, voice data, or sensor data.

3. The method of claim 1, wherein the binary operation executed on the set of permuted level hypervectors is at least one of a AND, OR, XOR, NAND, NOR, or XNOR operation.

4. The method of claim 1, wherein the permutation operation applied to each selected level hypervector is based on a predetermined number of positions reflective of an order of the sequence of data elements within the particular window.

5. The method of claim 1, wherein the set of level hypervectors is predefined, each representing a distinct quantized value corresponding to possible values of data elements.

6. The method of claim 1, further comprising associating each window hypervector with a unique identifier hypervector through a binary operation to incorporate global sequence information into the encoding.

7. The method of claim 6, wherein decoding the encoded hypervector includes utilizing the unique identifier hypervector to reconstruct the sequence of data elements from the encoded hypervector based on the global sequence information encoded by the unique identifiers.

8. The method of claim 1, wherein aggregating the window hypervectors includes a weighted aggregation based on a predetermined importance criterion assigned to each window.

9. The method of claim 1, further comprising normalizing the encoded hypervector to obtain a uniform vector magnitude across different instances of encoded data.

10. The method of claim 1, wherein adjacent windows of the plurality of windows have a shared subset of data elements at their interface so as to define an overlap of one or more final data elements from a first window and one or more beginning data elements of a subsequent window.

11. The method of claim 10, wherein a size of an overlapping portion between consecutive windows is adjusted according to a predetermined criterion related to sequential dependencies inherent in the obtained data.

12. An ASIC accelerator system for hyperdimensional computing (HDC) encoding, comprising:
a processor configured to:
receive data to be encoded via an input interface;
segment the received data into a plurality of windows, each comprising a sequence of data elements;
select, for each data element within a window, a corresponding level hypervector from a stored set of level hypervectors, where each level hypervector represents a quantized value of the data element in high-dimensional space;
apply permutation operations to each selected level hypervector based on its sequential position within the window to generate a set of permuted level hypervectors;
execute a binary operation on the set of permuted level hypervectors to produce a window hypervector representing the sequence of data elements for that window;
aggregate the window hypervectors from each window to generate an encoded hypervector, representative of the receive data in a hyperdimensional vector space; and
output the encoded hypervector via an output interface.

13. The system of claim 12, further comprising a memory module communicatively coupled to the processor, wherein the memory module stores the set of level hypervectors.

14. The system of claim 12, further comprising computer-readable instructions stored on a non-transitory computer-readable medium, wherein the instructions, when executed by the processor, cause the processor to perform tasks of receiving the data; segmenting the received data; selecting the corresponding level hypervector; applying permutation operations; executing the binary operation; aggregating the window hypervectors; and outputting the encoded hypervector.

15. The system of claim 12, wherein the received data comprises at least one of textual data, image data, voice data, or sensor data.

16. The system of claim 12, wherein the binary operation executed on the set of permuted level hypervectors is at least one of a AND, OR, XOR, NAND, NOR, or XNOR operation.

17. An ASIC accelerator system for hyperdimensional computing (HDC) encoding, comprising:
an input interface for receiving data to be encoded;
a data segmentation unit configured to segment the received data into a plurality of windows, each window comprising a sequence of data elements;
a level hypervector selection unit configured to select, for each data element within a window, a corresponding level hypervector from a set of level hypervectors stored in a level hypervector memory, wherein each level hypervector represents a quantized value of the data element in high-dimensional space;
a permutation unit configured to apply permutation operations to each selected level hypervector based on its sequential position within the window, resulting in a set of permuted level hypervectors for that window;
a binary operation unit configured to perform a binary operation on the set of permuted level hypervectors to produce a window hypervector representing the sequence of data elements for that window; and
an aggregation unit configured to aggregate the window hypervectors from each window to generate an encoded hypervector, representative of the receive data in a hyperdimensional vector space.

18. The system of claim 17, further comprising:
an output interface configured to output the encoded hypervector;
a level hypervector memory for storing the set of level hypervectors; and
an identifier hypervector memory for storing identifier hypervectors used in associating window hypervectors with unique identifiers.

19. The system of claim 17, wherein at least one of the data segmentation unit, the level hypervector selection unit, the permutation unit, the binary operation unit, or the aggregation unit is implemented by at least one processor configured to execute instructions for performing respective functions of that unit.

20. The system of claim 17, wherein adjacent windows of the plurality of windows have a shared subset of data elements at their interface so as to define an overlap of one or more final data elements from a first window and one or more beginning data elements of a subsequent window.

21-29. (canceled)
